(19) United States
(12) Patent Application Publication
(10) Pub. No.: US 2019/0082456 A1
(43) Pub. Date: Mar. 14, 2019

(54) METHOD FOR TRANSMITTING AND RECEIVING UPLINK DATA CHANNEL, AND APPARATUS THEREOF

(71) Applicant: ELECTRONICS AND TELECOMMUNICATIONS RESEARCH INSTITUTE, Daejeon (KR)

(72) Inventors: Cheul Soon KIM, Daejeon (KR); Sung Hyun MOON, Daejeon (KR); Choong Il YEH, Daejeon (KR); Jung Hoon LEE, Daejeon (KR)

(21) Appl. No.: 16/124,368

(22) Filed: Sep. 7, 2018

(30) Foreign Application Priority Data
Sep. 8, 2017 (KR) 10-2017-0115433
Sep. 28, 2017 (KR) 10-2017-0126155
Oct. 19, 2017 (KR) 10-2017-0136089
Mar. 23, 2018 (KR) 10-2018-0034050
May 9, 2018 (KR) 10-2018-0053229
Jun. 11, 2018 (KR) 10-2018-0066997
Aug. 9, 2018 (KR) 10-2018-0093037

(51) Int. Cl. H04W 72/12; H04L 5/00

(52) U.S. Cl. CPC H04W 72/1284; H04L 5/0055

(57) ABSTRACT

A method of transmitting a grant-free uplink data channel (physical uplink shared channel (PUSCH)) (GF-PUSCH), performed in a terminal, includes determining a resource (GF-PUSCH resource) for transmission of the GF-PUSCH and an identifier (DM-RS ID) of a demodulation reference signal (DM-RS) included in the GF-PUSCH; when an uplink traffic arrives, encoding the uplink traffic into a transport block (TB); generating the DM-RS based on the DM-RS ID, and transmitting the GF-PUSCH including the TB and the DM-RS to a base station through the GF-PUSCH resource; and receiving, from the base station, a group hybrid automatic repeat request acknowledgement (HARQ-ACK) information in which ACK or negative acknowledgement (ACK/NACK) information for the GF-PUSCH of the terminal and ACK/NACK information for at least one GF-PUSCH of at least one other terminal are multiplexed, through a downlink control information (DCI).

### CROSS-REFERENCE TO RELATED APPLICATIONS

This application claims priority to Korean Patent Application Nos. 10-2017-0115433, filed Sep. 8, 2017, 10-2017-0126155, filed Sep. 28, 2017, 10-2017-0136089, filed Oct. 19, 2017, 10-2018-0034050, filed Mar. 23, 2018, 10-2018-0053229, filed May 9, 2018, 10-2018-0066997, filed Jun. 11, 2018, and 10-2018-0093037, filed Aug. 9, 2018, in the Korean Intellectual Property Office (KIPO), the entire contents of which are hereby incorporated by reference.

### BACKGROUND

### 1. Technical Field

The present disclosure relates to a mobile communication system, more specifically, to a method for transmitting and receiving a grant-free uplink (UL) data channel, a method for transmitting and receiving downlink control information for the grant-free uplink data channel, and an apparatus for the same.

### 2. Description of Related Art

In the Ultra-Reliable Low-Latency Communication (URLLC) supported by the 3rd Generation Partnership Project (3GPP) New Radio (NR) system, in order to obtain a low delay time and a high reception quality, a terminal may transmit a scheduling, request (SR) to a serving base station when an uplink URLLC traffic arrives. However, according to this scheme, since it takes a large delay time from when the terminal transmits the SR to when the terminal receives an uplink grant, a method of omitting the round trip latency between the terminal and the serving base station is required.

### SUMMARY

Accordingly, embodiments of the present disclosure provide an operation method of a terminal for transmitting a grant-free uplink data channel.

Accordingly, embodiments of the present disclosure also provide an operation method of a base station for receiving a grant-free uplink data channel.

Accordingly, embodiments of the present disclosure also provide a terminal for transmitting a grant-free uplink data channel.

In order to achieve the objective of the present disclosure, a method of transmitting a grant-free uplink data channel (physical uplink shared channel (PUSCH)) (GF-PUSCH), performed in a terminal, may comprise determining a resource (GF-PUSCH resource) for transmission of the GF-PUSCH and an identifier (DM-RS ID) of a demodulation reference signal (DM-RS) included in the GF-PUSCH; when an uplink traffic arrives, encoding the uplink traffic into a transport block (TB); generating the DM-RS based on the DM-RS ID, and transmitting the GF-PUSCH including the TB and the DM-RS to a base station through the GF-PUSCH resource; and receiving, from the base station, a group hybrid automatic repeat request acknowledgement (HARQ-ACK) information in which ACK or negative acknowledgement (ACK/NACK) information for the GF-PUSCH of the terminal and ACK/NACK information for at least one GF-PUSCH of at least one other terminal are multiplexed, through a downlink control information (DCI).

The group ACK/NACK information may be configured to comprise at most M DM-RS IDs detected by the base station in each of N GF-PUSCH resources or a bit string including values derived from the at most M DM-RS IDs, wherein N is a natural number equal to or greater than 1, and M is a natural number equal to or greater than 1.

The bit string may further include an identifier of a GF-PUSCH resource in which one or more DM-RSs are detected by the base station.

The bit string may further include a number of DM-RS IDs detected by the base station in each of the N GF-PUSCH resources.

The group ACK/NACK information may be configured as a bitmap indicating at most M DM-RS IDs detected by the base station in each of N GF-PUSCH resources or values derived from the at most M DM-RS IDs, wherein N is a natural number equal to or greater than 1, and M is a natural number equal to or greater than 1.

The GF-PUSCH resource may be configured to the terminal by the serving base station, or may be selected by the terminal in a resource pool configured to the terminal by the serving base station through a higher layer signaling.

The method may further comprise receiving a number K of repetitive transmissions for the GF-PUSCH from the base station, and in the transmitting the GF-PUSCH, the GF-PUSCH may be repetitively transmitted to the base station K times.

When the ACK/NACK information for the GF-PUSCH of the terminal indicates ACK after k (k≤K) repetitive transmissions of the GF-PUSCH, the transmission of the GF-PUSCH may be early terminated.

In order to achieve the objective of the present disclosure, a method of receiving a grant-free uplink data channel (physical uplink shared channel (PUSCH)) (GF-PUSCH), performed in a base station, may comprise detecting a demodulation reference signal (DM-RS) of the GF-PUSCH transmitted from a terminal through a resource (GF-PUSCH resource) for transmission of the GF-PUSCH, and determining an identifier (DM-RS ID) of the DM-RS; decoding a transport block (TB) included in the GF-PUSCH based on the detected DM-RS; transmitting, to the terminal, a group hybrid automatic repeat request acknowledgement (HARQ-ACK) information in which ACK or negative acknowledgement (ACK/NACK) information for the GF-PUSCH of the terminal and ACK/NACK information for at least one GF-PUSCH of at least one other terminal are multiplexed, through a downlink control information (DCI), the ACK/NACK information for the GF-PUSCH of the terminal being generated according to a result of the decoding of the TB.

The group ACK/NACK information may be configured to comprise at most M DM-RS IDs detected by the base station in each of N GF-PUSCH resources or a bit string including values derived from the at most M DM-RS Ins, wherein N is a natural number equal to or greater than 1, and M is a natural number equal to or greater than 1.

The bit string may further include an identifier of a GF-PUSCH resource in which one or more DM-RSs are detected by the base station.

The bit string may further include a number of DM-RS IDs detected by the base station in each of the N GF-PUSCH resources.

The group ACK/NACK information may be configured as a bitmap indicating at most M DM-RS IDs detected by the base station in each of N GF-PUSCH resources or values derived from the at most M DM-RS IDs, wherein N is a natural number equal to or greater than 1, and M is a natural number equal to or greater than 1.

The GF-PUSCH resource may be configured to the terminal by the serving base station, or may be selected by the terminal in a resource pool configured to the terminal by the serving base station through a higher layer signaling.

The method may further comprise indicating a number K of repetitive transmissions for the GF-PUSCH to the terminal, and the GF-PUSCH may be repetitively transmitted K times from the terminal through the GF-PUSCH resource.

When the decoding of the TB succeeds after k (k≤K) repetitive transmissions of the GF-PUSCH, the transmission of the GF-PUSCH of the terminal may be early terminated by transmitting ACK/NACK information indicating ACK for the GF-PUSCH of the terminal as multiplexed in the group ACK/NACK information.

In order to achieve the objective of the present disclosure, a terminal for transmitting a grant-free uplink data channel (physical uplink shared channel (PUSCH)) (GF-PUSCH) may comprise at least one processor, a memory storing at least one instruction executed by the at least one processor, and a transceiver controlled by the at least one processor. Also, the at least one instruction may be configured to determine a resource (GF-PUSCH resource) for transmission of the GF-PUSCH and an identifier (DM-RS ID) of a demodulation reference signal (DM-RS) included in the GF-PUSCH; when an uplink traffic arrives, encode the uplink traffic into a transport block (TB); generate the DM-RS based on the DM-RS ID, and transmit the GF-PUSCH including the TB and the DM-RS to a base station through the GF-PUSCH resource; and receive, from the base station, a group hybrid automatic repeat request acknowledgement (HARQ-ACK) information in which ACK or negative acknowledgement (ACK/NACK) information for the GF-PUSCH of the terminal and ACK/NACK information for at least one GF-PUSCH of at least one other terminal are multiplexed, through a downlink control information (DCI).

The group ACK/NACK information may be configured to comprise at most M DM-RS IDs detected by the base station in each of N GF-PUSCH resources or a bit string including values derived from the at most M DM-RS IDs, wherein N is a natural number equal to or greater than 1, and M is a natural number equal to or greater than 1.

The group ACK/NACK information may be configured as a bitmap indicating at most M DM-RS IDs detected by the base station in each of N GF-PUSCH resources or values derived from the at most M DM-RS IDs, wherein N is a natural number equal to or greater than 1, and M is a natural number equal to or greater than 1.

The GF-PUSCH resource may be configured to the terminal by the serving base station, or may be selected by the terminal in a resource pool configured to the terminal by the serving base station through a higher layer signaling.

According to the embodiments of the present disclosure, a low delay time and a high reception quality of a mobile communication system can be achieved.

### BRIEF DESCRIPTION OF DRAWINGS

Embodiments of the present disclosure will become more apparent by describing in detail embodiments of the present disclosure with reference to the accompanying drawings, in which:

FIG. 1 is a conceptual diagram illustrating a mobile communication system according to a first embodiment of the present disclosure;

FIG. 2 is a block diagram illustrating a communication node in a mobile communication system according to a first embodiment of the present disclosure;

FIG. 3 is a sequence chart for explaining a GF-PUSCH transmission procedure in which K repetitive transmissions are configured when an early termination is not applied;

FIG. 4 is a sequence chart for explaining a. GF-PUSCH transmission procedure in which K repetitive transmissions are configured when an early termination is applied;

FIG. 5 is a flow chart for explaining a DL HARQ-ACK state determination method of a serving base station in a GF PUSCH transmission for which K repetitive transmissions are configured;

FIG. 6 is a conceptual diagram illustrating a UL HARQ-ACK for a PDSCH;

FIG. 7 is a conceptual diagram for explaining an example of a first method for representing a group HARQ-ACK;

FIG. 8 is a conceptual diagram for explaining another example of a first method for representing a group HARQ-ACK;

FIG. 9 is a conceptual diagram for explaining yet another example of a first method for representing a group HARQ-ACK;

FIG. 10 is a conceptual diagram for explaining a method of transmitting a DCI for each GF-PUSCH resource;

FIG. 11 is a conceptual diagram for explaining an example of a second method for representing a group HARQ-ACK;

FIG. 12 is a conceptual diagram for explaining another example of a second method for representing a group HARQ-ACK;

FIG. 13 is a conceptual diagram for explaining a case of operating 2 UL HARQ processes for GF-PUSCH transmission;

FIG. 14 is a conceptual diagram for explaining a case of operating only one UL HARQ process for GF-PUSCH transmission;

FIGS. 15 and 16 are sequence charts for explaining a case of operating only one HARQ process for GF-PUSCH transmission for which K repetitive transmissions are configured;

FIG. 17 is a conceptual diagram for explaining factors constituting a time budget required for a serving base station to transmit a PDSCH and receive a PUCCH;

FIG. 18 is a conceptual diagram for comparing delay times of a PSK modulation based PUCCH and an OOK modulation based PUCCH;

FIG. 19 is a conceptual diagram for explaining a case where PDSCH repetitive transmissions and a HARQ-ACK feedback are performed by a conventional scheme;

FIG. 20 is a conceptual diagram for explaining an early termination scheme for the PDSCH repetitive transmission;

FIGS. 21A and 21B are conceptual diagrams for respectively explaining a beam sweeping using multiple transmission points and a beam sweeping using a single transmission point;

FIG. 22 is a conceptual diagram for explaining an early termination scheme for the PDSCH sweeping transmission;

FIG. 23 is a conceptual diagram for explaining an early termination scheme for the PDSCH occasion;

FIG. 24 is a conceptual diagram for explaining an example of a method of determining a PUCCH occasion;

FIG. 25 is a conceptual diagram illustrating a case where a subcarrier spacing of a PDSCH is smaller than a subcarrier spacing of a PUCCH;

FIG. 26 is a conceptual diagram illustrating a case where a subcarrier spacing of a PDSCH is larger than a subcarrier spacing of a PUCCH;

FIG. 27 is a conceptual diagram for explaining a case where a PUCCH occasion is determined based on the last PDSCH instance;

FIG. 28 is a conceptual diagram for explaining a case where a PUCCH occasion is determined based on a first PDSCH instance;

FIG. 29 is a conceptual diagram for explaining a case where a PUCCH occasion is derived based on all PDSCH instances;

FIG. 30 is a conceptual diagram for explaining a case where a PUCCH occasion is determined based on a first successful PDSCH instance;

FIG. 31 is a conceptual diagram for explaining another case where a PUCCH occasion is determined based on a first successful PDSCH instance;

FIG. 32 is a conceptual diagram for explaining a case where a payload is changed in a PUCCH occasion for a PDSCH occasion composed of K PDSCH instances;

FIG. 33 is a conceptual diagram illustrating a configuration of a PUCCH occasion starting at a boundary of a slot;

FIG. 34 is a conceptual diagram illustrating a configuration of a PUCCH occasion starting at a position within a slot;

FIG. 35 is a conceptual diagram illustrating a configuration of a PDSCH occasion starting at a boundary of a slot; and

FIG. 36 is a conceptual diagram illustrating a configuration of a PUSCH occasion starting at a position within a slot.

### DETAILED DESCRIPTION

Embodiments of the present disclosure are disclosed herein. However, specific structural and functional details disclosed herein are merely representative for purposes of describing embodiments of the present disclosure, however, embodiments of the present disclosure may be embodied in many alternate forms and should not be construed as limited to embodiments of the present disclosure set forth herein.

Accordingly, while the present disclosure is susceptible to various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present disclosure will be described in greater detail with reference to the accompanying drawings.

Throughout the specification, a terminal may be a mobile terminal (MT), a mobile station (MS), an advanced mobile station (AMS), a, high reliability mobile station (HR-MS), a subscriber station (SS), a portable subscriber station (PSS), an access terminal (AT), an user equipment (UE), or the like. Also, the terminal may include all or a part of functions of MT, MS, AMS, HR-MS, SS, PSS, AT, UE, or the like.

Also, a base station may be an advanced base station (ABS), a high reliability base station (HR-BS), a node B, an evolved node B (eNB), an access point (AP), a radio access station (RAS), a base transceiver station (BTS), a mobile multi-hop relay (MMR)-BS, a relay station (RS) performing a role of the base station, a high reliability relay station (HR-RS) performing a role of the base station, a small cell base station, or the like. Also, the base station may include all or a part of functions of BS, ABS, HR-BS, node B, eNB, AP, RAS, BTS, MMR-BS, RS, HR-RS, small cell base station, or the like.

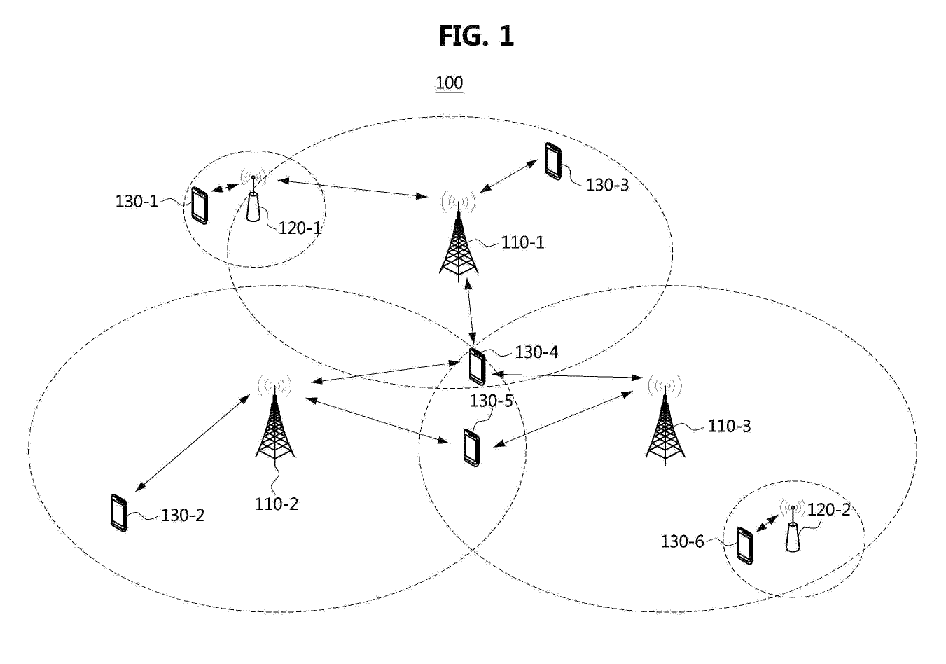

FIG. 1 is a conceptual diagram illustrating a mobile communication system according to a first embodiment of the present disclosure.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. Each of the plurality of communication nodes may support at least one communication protocol. For example, each of the plurality of communication nodes may support at least one communication protocol among a code division multiple access (CDMA) based communication protocol, a wideband CDMA (WCDMA) based communication protocol, a time division multiple access (TDMA) based communication protocol, a frequency division multiple access (FDMA) based communication protocol, an orthogonal frequency division multiplexing (OFDM) based communication protocol, an orthogonal frequency division multiple access (OFDMA) based communication protocol, a single carrier FDMA (SC-FDMA) based communication protocol, a non-orthogonal multiple access (NOMA) based communication protocol, and a space division multiple access (SDMA) based communication protocol. Also, each of the plurality of communication nodes may have the following structure.

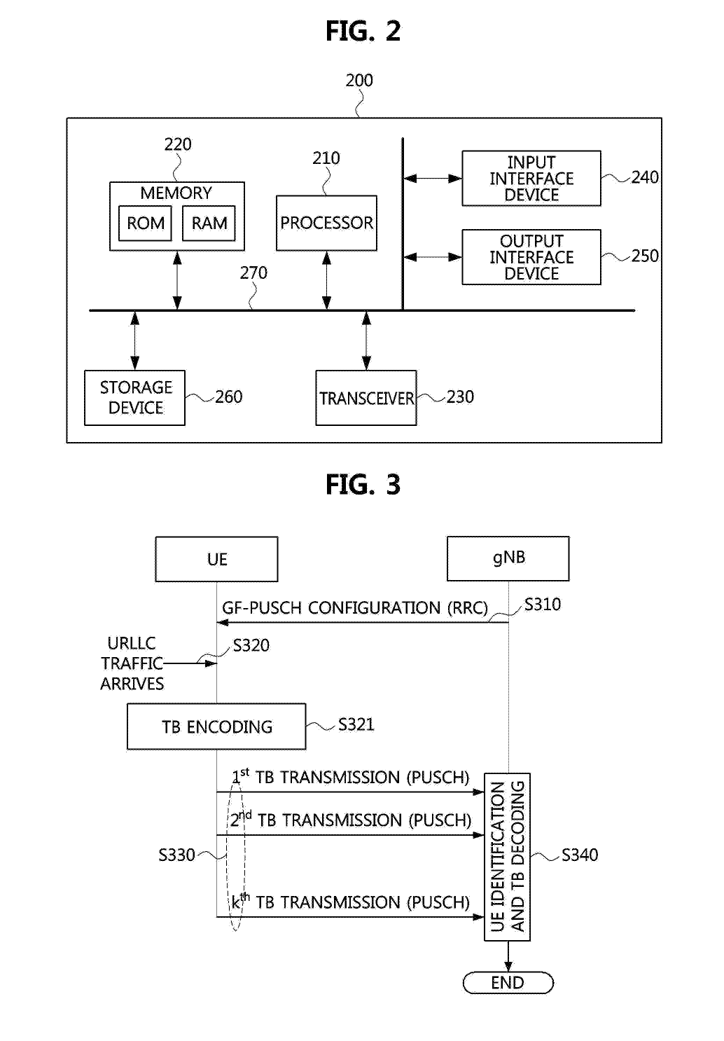

FIG. 2 is a block diagram illustrating a communication node in a mobile communication system according to a first embodiment of the present disclosure.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may be connected to the processor 210 via an individual interface or a separate bus, rather than the common bus 270. For example, the processor 210 may be connected to at least one of the memory 220, the transceiver 230, the input interface device 240, the output interface device 250, and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B, a evolved Node-B (eNB), a base transceiver station (BTS), a radio base station, a radio transceiver, an access point, an access node, a road side unit (RSU), a digital unit (DU), a cloud digital unit (CDU), a radio remote head (RRH), a radio unit (RU), a transmission point (TP), a transmission and reception point (TRP), a relay node, or the like. Also, each of the plurality of terminals 130-1, 130-2, 130-3, 130-4, 130-5, and 130-6 may refer to a terminal, an access terminal, a mobile terminal, a station, a subscriber station, a mobile station, a portable subscriber station, a node, a device, or the like.

Each of the plurality of communication nodes 110-1, 110-2, 110-3, 120-1, 120-2, 130-1, 130-2, 130-3, 1304, 130-5, and 130-6 may support a long-term evolution (LTE), a LTE-Advanced (LTE-A), or the like defined in the cellular communication standard (e.g., 3GPP standard). Each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

Each of the plurality of base stations 110-1, 110-2, 110-3, 120-1, and 120-2 may support OFDMA-based downlink transmission and SC-FDMA based uplink transmission. Also, each of the plurality of base stations 110-1, 110-2, 110-3, 120-1, and 120-2 may support a multi-input multi-output (MIMO) transmission (e.g., a single-user MIMO (SU-MIMO), a multi-user MIMO (MU-MIMO), a massive MIMO, or the like), a coordinated multipoint (CoMP) transmission, a carrier aggregation (CA) transmission, a transmission in unlicensed band, a device-to-device (D2D) communications (or, proximity services (ProSe)), or the like. Here, each of the plurality of terminals 130-1, 130-2, 130-3, 1304, 130-5, and 130-6 may perform operations corresponding to the operations of the plurality of base stations 110-1, 110-2, 110-3, 120-1, and 120-2 (i.e., the operations supported by the plurality of base stations 110-1, 110-2, 110-3, 120-1, and 120-2).

For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner. The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 1304, 130-5, or 130-6 which belongs to its cell coverage in the CA manner. Each of the base stations 110-1, 110-2, and 110-3 may control D2D communications between the fourth terminal 130-4 and the fifth terminal 130-5, and thus, the fourth terminal 130-4 and the fifth terminal 130-5 may perform the D2D communications under control of the second base station 110-2 and the third base station 110-3.

Hereinafter, even when a method (e.g., transmission or reception of a signal) to be performed in a first communication node among communication nodes is described, a corresponding second communication node may perform a method (e.g., reception or transmission of the signal) corresponding to the method performed in the first communication node. That is, when an operation of a terminal is described, a corresponding base station may perform an operation corresponding to the operation of the terminal. Conversely, when an operation of the base station is described, the corresponding terminal may perform an operation corresponding to the operation of the base station.

Grant-Free Uplink Data Channel Transmission

In the uplink (UL) Ultra-Reliable Low-Latency Communication (URLLC) supported by the NR system, in order to obtain a low delay time and a high reception quality, a terminal (UE) may transmit a scheduling request (SR) to a serving base station when a UL URLLC traffic to be transmitted arrives. However, according to this scheme, since it takes a large delay time from when the terminal transmits the SR to when the terminal receives a UL grant, a method of omitting the round trip latency between the terminal and the serving base station is required.

Accordingly, a scheme, in which the serving base station preconfigures resources to the UE through a radio resource control (RRC) signaling, and when the UE detects an arrival event that the UL URLLC traffic arrives, the UE transmits a UL data channel (i.e., a physical uplink shared channel (PUSCH)) without a UL grant, may be considered. Here, the UL data channel transmitted without a UL grant may be referred to as a ‘grant-free PUSCH (GF-PUSCH)’. In the scheme in which the serving base station allocates a dedicated resource to each UE to allow each UE to transmit the GF-PUSCH, as the number of UEs supporting the URLLC increases, resources that can be allocated by dynamic scheduling may be reduced. Assuming a race in which an arrival rate of the UL URLLC traffic is low, the serving base station may assign two or more UEs to one resource. However, in this manner, when the UEs inadvertently transmit the GF-PUSCHs in the same resource, the reception quality for the UEs at the serving base station may be lowered. Accordingly, the serving base station may configure the UEs to perform K (=>1) repetitive transmissions.

The parameters configured by the serving base station to the UE through an RRC signaling in order to support the GF-PUSCH transmission may include, for each grant-free resource (hereinafter, ‘GF-PUSCH resource’), at least one of a time resource, a frequency resource, a UE-specific demodulation reference signal (DM-RS) configuration, an index of a modulation and coding scheme (MCS) applied to a GF-PUSCH, a transport block size applied to a GF-PUSCH, a value of K (i.e., the number of repetitive transmissions), a parameter for determining a transmission power, and the like.

FIG. 3 is a sequence chart for explaining a GF-PUSCH transmission procedure in which K repetitive transmissions are configured when an early termination is not applied.

Referring to FIG. 3, a serving base station (e.g., gNB) may configure a GF-PUSCH transmission to a UE (S310), and when a URLLC traffic arrives at the UE (S320), the UE may encode the URLLC traffic into a transport block (TB) (S321). The UE may repetitively transmit the GF-PUSCH K times without a UL grant through a GF-PUSCH resource configured by the serving base station (S330). The serving base station may identify the UE using a PUSCH DM-RS from signals received from UEs, perform channel estimation based on the PUSCH DM-RS, and decode the encoded TB (S340).

On the other hand, in the step S340, even when the serving base station receives the GF-PUSCH less than K times, if the TB is successfully demodulated and decoded, it may not be necessary to receive the GF-PUSCH anymore.

That is, although the UE is configure to repeat the GF-PUSCH transmission K times, if the serving base station succeeds in decoding the TB with fewer times, the UE may no longer need to transmit the GF-PUSCH. If the GF-PUSCH is not unnecessarily transmitted, it does not cause interference to other UEs, so that a collision probability with other UEs in the same GF-PUSCH resource can be lowered. Accordingly, it is preferable that the serving base station controls the UE to no longer transmit the GF-PUSCH in this situation. This control may preferably use a layer 1 (L1) signaling to reduce a delay time required for the control.

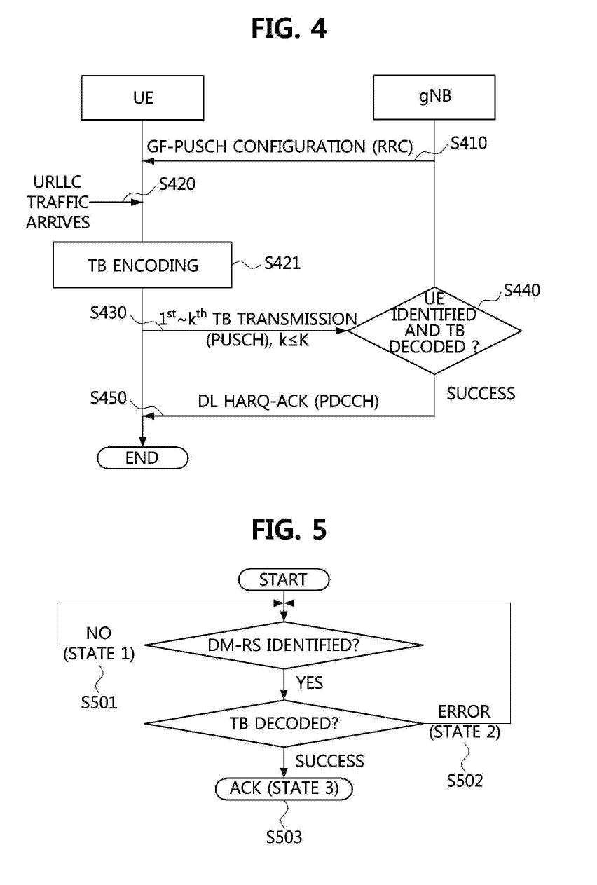

FIG. 4 is a sequence chart for explaining a GF-PUSCH transmission procedure in which K repetitive transmissions are configured when an early termination is applied.

Comparing an example of FIG. 4 with the example of FIG. 3, in the example of FIG. 4, when the serving base station receives the GF-PUSCH k (k<K) times and successfully decodes the TB, the serving base station may terminate the transmission of the GF-PUSCH early by transmitting to the corresponding UE a downlink (DL) hybrid automatic repeat request acknowledgement (HARQ-ACK) through a downlink control channel (e.g., a physical downlink control channel (PDCCH)).

After the UE repeatedly transmits the GF-PUSCH k times (S430), the UE may receive the PDCCH including the DL HARQ-ACK through the L1 signaling (S450). In this case, the UE having received the PDCCH may perform an operation of further retransmitting the GF-PUSCH up to K times (i.e., when the HARQ-ACK indicates negative acknowledgement (NACK)), or an operation of flushing a HARQ buffer (i.e., when the HARQ-ACK indicates ACK).

Here, there are three DL HARQ-ACK states (e.g., state 1, state 2, and state 3 described later with reference to FIG. 5) that the serving base station can distinguish. The serving base station may configure a sufficiently large K to the UE (S310), and when the UE does not receive any signaling from the serving base station while transmitting the GF-PUSCH k (k<K) times, the UE may regard the DL HARQ-ACK for the corresponding TB as NACK.

FIG. 5 is a flow chart for explaining a DL HARQ-ACK state determination method of a serving base station in a GF PUSCH transmission for which K repetitive transmissions are configured.

Referring to FIG. 5, a state in which the serving base station fails to detect a PUSCH DM-RS (i.e., DM-RS ID) of the GF-PUSCH transmitted by the UE may correspond to a NACK state (S501, the state 1). In this case, the serving base station is not able to determine whether or not the PUSCH DM-RS of the GF-PUSCH is successfully received. Therefore, the serving base station may not transmit ACK or NACK.

Meanwhile, a state in which the serving base station detects a PUSCH DM-RS ID of the GF-PUSCH but fails to decode a TB from the GF-PUSCH may also correspond to a NACK state and correspond to the state 2 (S502). In this case, the serving base station may switch the transmission of the corresponding TB from the GF-PUSCH transmission to a grant-based PUSCH transmission (hereinafter, referred to as ‘GB-PUSCH’ transmission). That is, the serving base station may transmit a UL grant to the corresponding UE, and control the UE to retransmit the same TB using the GB-PUSCH while maintaining a HARQ process ID. When the UE receives such the UL grant, it is preferable that the UE no longer transmits the TB as the GF-PUSCH. Even though the serving base station does not explicitly transmit NACK to the UE, the UL grant may act as NACK.

Finally, a state (S503, the state 3) of FIG. 5 may correspond to a case in which the serving base station detects a PUSCH DM-RS ID of the GF-PUSCH and decodes a TB from the GF-PUSCH, and may correspond to an ACK state. In this case, the serving base station may transmit a DL HARQ-ACK indicating ACK to the corresponding UE so as not to transmit the GF-PUSCH any more (i.e., early termination). When the UE receives the ACK, the UE may preferably stop transmission of the corresponding TB through the GF-PUSCH transmission.

The serving base station may transmit the DL HARQ-ACK using a PDCCH, and the serving base station may scramble the PDCCH by using a group common ID or a group common RNTI (GC-RNTI), and transmit the same so that all UEs transmitting GF-PUSCHs can receive the PDCCH. The UEs configured to perform the GF-PUSCH transmission may belong to one UE group, and may decode the PDCCH including the DL HARQ-ACK for the GF-PUSCH.

The serving base station may operate several UE groups. In this case, in order to reduce blind decoding complexity of the UE, the serving base station may perform scrambling for the PDCCH differently for each UE group. The UE may be allocated a parameter capable of descrambling the PDCCH from the serving base station. The UE may perform a UE group hopping for each GF-PUSCH transmission according to a configuration of the serving base station. Alternatively, the UE may perform a GF-PUSCH resource hopping for each GF-PUSCH transmission according to a configuration of the serving base station.

The serving base station may configure a single UL HARQ process to the UE through the RRC signaling for GF-PUSCH transmission of the UE. This may be applied to a case where a UL traffic using the GF-PUSCH transmission does not arrive at the UE frequently. For example, this may correspond to a case where the arrival rate of the UL traffic using the GF-PUSCH transmission is sufficiently low, and thus a new UL traffic does not arrive at the UE while the GF-PUSCH is repeatedly transmitted K times.

On the other hand, when the arrival rate of the UL traffic using the GF-PUSCH is not sufficiently low and the value of K is large, a new UL traffic may further arrive at the UE before the UE delivers one. TB to the serving base station. In this case, two or more UL HARQ processes are needed. In the case of performing the GF-PUSCH repetitive transmissions while operating two or more UL HARQ processes, the UE should be able to identify the GF-PUSCH resource applied to each UL HARQ process through appropriate RRC configuration from the serving base station.

When the UE is located at a cell edge, a round trip delay with the serving base station may be very large and a path loss may also be large. Thus, the above-described GF-PUSCH transmission may be useful when the UE is difficult to increase a transmission power further and the delay time of the UL URLLC traffic increases.

On the other hand, when the UE is located at a cell center, since the round trip delay with the serving base station is small and the UE can increase the transmission power, the GB-PUSCH transmission using the SR may be used.

On the other hand, when the UE is located between the cell center and the cell edge, the GF-PUSCH without the SR may be transmitted, or the GB-PUSCH with the SR may be transmitted to lower a collision probability. Here, in order to transmit the SR to the serving base station, the UE may use a diversity scheme. The diversity scheme may include a macro diversity using multiple Tx/Rx points of the serving base station, a link-level transmit diversity and transmit antenna selection, a link-level receive diversity, a frequency diversity, a time diversity, and the like. When the number of antennas of the UE and the serving base station is not large, the frequency diversity and the time diversity may be considered. In the case that the frequency diversity is applied, a power spectral density may be lowered because the UE transmits the SR in a wide bandwidth. In the case that the time diversity is applied, the UE may have to use a large number of symbols, which makes it difficult to meet the delay time required by the UL URLLC. Since such the diversity schemes should be able to allocate a large number of resources to the UE, they may be inefficient.

Meanwhile, a scenario in which a downlink (DL). URLLC is transmitted in the NR system may be considered.

In order to obtain a low delay time and a high reception quality in a DL URLLC supported by the NR system, the UE may minimize the delay time by transmitting a UL HARQ-ACK to the serving base station promptly from when a DL URLLC traffic arrives, or reduce the delay time by omitting the UL HARQ-ACK. When the UL HARQ-ACK is omitted, since it is difficult for the serving base station to perform an appropriate link adaptation for the UE, a sufficiently low encoding rate should be applied to a PDCCH and a physical downlink shared channel (PDSCH), and thus resources may be inefficiently used. Also, if a physical (PHY) layer does not recognize an error of a TB, a large delay may occur because a higher layer (e.g., radio link control (RLC) layer) should recognize this. Therefore, it is preferable to apply a scheme that uses the UL HARQ-ACK but minimizes the delay time required for the UL HARQ-ACK.

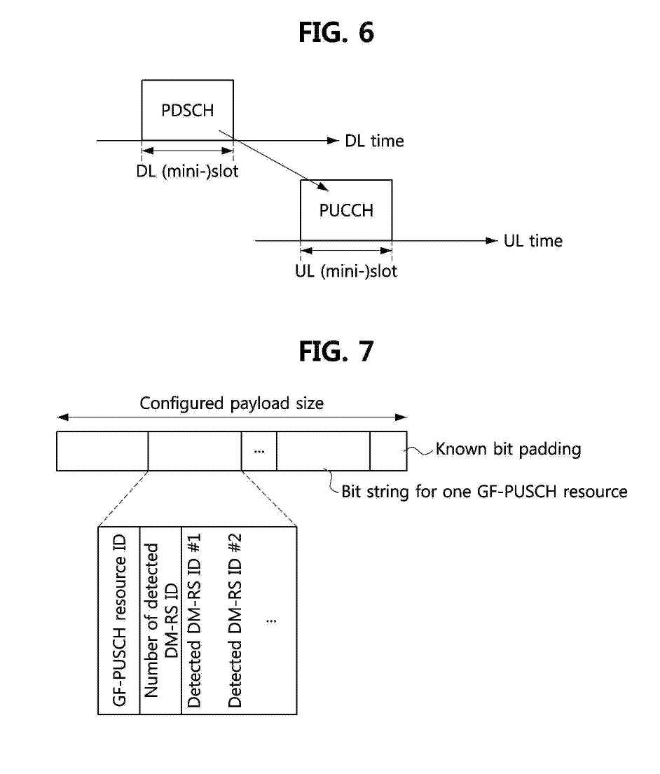

FIG. 6 is a conceptual diagram illustrating a UL HARQ-ACK for a PDSCH.

FIG. 6 illustrates a relationship between a general PDSCH and a general PUCCH in the NR system, and may be applied to both a frequency division multiplexing (FDD) and a time division multiplexing (TDD). Unlike the conventional Lit system, a transmission timing of a PUCCH corresponding to a PDSCH in the NR system may be configured in units of slots (or minislots) or symbols.

The number of DL symbols allocated to the PDSCH and the number of UL symbols allocated to the PUCCH may be configured by the serving base station, thereby satisfying the delay time required for the URLLC. The UE may receive parameters required for transmitting the UL URLLC traffic from the serving base station through the RRC signaling.

GF-PUSCH Resource Configuration

The UE may receive a configuration of GF-PUSCH resource and a configuration of DM-RS from the serving base station (gNB) through the RRC signaling. The configuration of the GF-PUSCH resource may indicate a time resource and a frequency resource belonging to an uplink bandwidth part (UL BWP). One GF-PUSCH resource may be composed of one or more resource units. Here, the resource unit may consist of consecutive physical resource blocks (PRBs) or consecutive symbols. Thus, one GF-PUSCH resource may be localized or distributed in the frequency domain. Also, one GF-PUSCH resource may be defined as a unit for transmitting one TB.

The UE may use a different GF-PUSCH resource each time a TB is transmitted even when one GF-PUSCH resource is configured. For example, when the UE is configured to transmit one TB twice (i.e., K=2), an index of a PRB and an index of a UL slot or minislot used for the first transmission may be different from an index of a PRB and an index of a UL slot or minislot used for the second transmission. That is; the GF-PUSCH resource configuration may include resource hopping.

The UE may use a different DM-RS resource each time a TB is transmitted even when, one DM-RS resource is configured. For example, when a UE configured to use transform precoding is configured to transmit one TB twice, a base sequence index and a cyclic shift index used for the first transmission may be different from a base sequence index and a cyclic shift index used for the second transmission. That is, the GF-PUSCH DM-RS configuration may include sequence hopping. In another example, when the UE configured not to use transform precoding is configured to transmit one TB twice, scrambling identification information (scrambling ID) of a sequence used for the first transmission may be different from scrambling identification information of a sequence used for the second transmission.

For convenience of explanation; it may be assumed that a GF-PUSCH resource ID indicates these resources and a hopping pattern of these resources. The UE may identify resources allowed to transmit the GF-PUSCH based on the GF-PUSCH resource ID. In a similar manner, the UE may identify a DM-RS resource to use when transmitting the GF-PUSCH based on a GF-PUSCH DM-RS ID.

In an embodiment, the GF-PUSCH resource ID may be derived from an RNTI of the UE, a UL slot or minislot index of the UE, or a combination thereof. The UE may identify the resources allowed to transmit the GF-PUSCH based on the GF-PUSCH resource ID. The DM-RS ID used by the UE may be configured through the RRC signaling.

In another embodiment the UE may be configured a GF-PUSCH resource pool through a higher layer signaling (i.e., RRC signaling), and configured a DM-RS ID. The GF-PUSCH resource ID used when the UE transmits the GF-PUSCH may be selected by the UE among time resources and frequency resources belonging to the GF PUSCH resource pool. The GF-PUSCH resource ID selected by the UE may be derived from the RNTI of the UE, the UL slot or minislot index of the UE, or the combination thereof according to a rule defined in, the technical specification. In a similar manner, the UE may operate without signaling indicating the DM-RS ID. That is, the serving base station may configure only the GF-PUSCH resource pool to the UE through the RRC signaling, and the GF-PUSCH resource and DM-RS ID used by the UE for the GF-PUSCH transmission may be derived from the RNTI of the UE, the UL slot or minislot index of the UE, or the combination thereof according to a rule defined in the technical specification.

By applying the above-described methods, the location of the time resource and the location of the frequency resource in which the UE transmits the GF-PUSCH may be determined. Also, the DM-RS ID used by the UE should be unique within the corresponding GF-PUSCH resource. The rule configured by the serving base station or defined in the technical specification should be defined so that one DM-RS ID can be assigned to at most one UE within the GF-PUSCH resource. The DM-RS ID may be preferably orthogonal to the other DM-RSs.

Group HARQ-ACK Configuration for GF-PUSCH Resource

The serving base station may multiplex one or more ACK/NACK information for PUSCH or GF-PUSCH transmission of one or more UEs to generate a single downlink control information (DCI), and transmit the DCI to the one or more UEs via a PDCCH. This may be defined as a ‘group HARQ-ACK’. In this case, the serving base station may signal a GF-PUSCH resource in which a GF-PUSCH is received, an identifier (ID) of a DM-RS detected in the corresponding GF-PUSCH resource, a value derived from the DM-RS ID, a HARQ-ACK for a TB, or a value derived from the HARQ-ACK to the UEs by including the values in a payload of the DCI or the PDCCH.

A case, where the serving base station configures at most N (N is a natural number equal to or greater than 0) GF-PUSCH resource IDs of GF-PUSCH resources in which a PUSCH DM-RS is detected in the payload of the DCI, and configures at most M (M is a natural number equal to or greater than 0) detected. DM-RS IDs for each GF-PUSCH resource ID in the payload of the DCI, may be considered. Here, the GF-PUSCH resource may correspond to one or more cells or BWPs. The number of DM-RS IDs detected by the serving base station in the n-th GF-PUSCH resource may be assumed to be Mn. That is, Mn may be equal to or less than M. Also, the serving base station may configure the size of the payload of the DCI included in the PDCCH to the UE by the RRC signaling.

As an example of this scheme, the serving base station may configure M and N to the UE through the RRC signaling. Since the UE can determine a coding rate through this, the UE may obtain the DCI by decoding the PDCCH using a polar decoder.

Since the UE knows the GF-PUSCH resource ID used by the UE among one or more GF-PUSCH resources included in the DCI, when a PDCCH including a group HARQ-ACK is configured through the RRC signaling, the terminal may know in which part of a given DCI a DM-RS ID should be detected even without a separate signaling. Alternatively, when the DCI or PDCCH including the group HARQ-ACK is configured through the RRC signaling, the UE may identify in which part of a given DCI belonging to the PDCCH a DM-RS ID should be detected by using a separate field belonging to an information element configuring the PDCCH for the group HARQ-ACK. In this case, it may be assumed that the configured location corresponds to the GF-PUSCH resource ID in one-to-one manner.

Hereinafter, methods of representing the group HARQ-ACK will be described.

(1) Method of Using a Correspondence Relationship for UE ID (RAR Based Approach)

The ID of the UE transmitting the GF-PUSCH may be configured to correspond to the ID of the GF-PUSCH resource through which the GF-PUSCH of the corresponding UE is transmitted and the DM-RS ID of the corresponding GF-PUSCH or a value derived from the DM-RS ID in one-to-one manner.

When the serving base station detects the PUSCH DM-RS ID, a part of the payload may be used to indicate the GF-PUSCH resource ID of the GF-PUSCH resource in which the PUSCH DM-RS ID is detected. For example, [log₂ N] bits may be used. Alternatively, in order to omit the bits representing the GF-PUSCH resource ID, the serving base station may concatenate information on detected DM-RS IDs in the order of the GF-PUSCH resource IDs.

A part of the payload may be used to indicate the DM-RS ID detected in each GF-PUSCH resource. For example, [log₂ M] bits may be used to represent the detected DM-RS ID. The serving base station may generate a bit string by concatenating the generated bits according to a predetermined rule, and may generate a PDCCH through appropriate channel coding and modulation.

As an example, the serving base station may allocate a different scrambling ID to each GF-PUSCH resource ID (i.e., GF-PUSCH resource). As another example, the serving base station may allocate the same scrambling ID to different GF-PUSCH resource IDs (i.e., GF-PUSCH resources). The UE may know which scrambling ID to monitor in order to detect a DL HARQ-ACK for the GF-PUSCH. The number of such the scrambling IDs being monitored may be limited to one, and necessary parameters may be transferred from the serving base station to the UE.

### \textcircled{1} First Example

A first example corresponds to a case where the size of the DCI is variable. In order to prevent a coding rate of the DCI from changing even when the number of DM-RSs detected by the serving base station changes, known bits (e.g., 0 or 1) may be added to a bit string smaller than the maximum length, so that the UE may know in advance the coding rate of the DCI (i.e., the fixed code rate).

For example, a case where 8 DM-RS IDs (M=8) are assigned to 4 GF-PUSCH resources (N=4) may be considered. That is, 2 DM-RSs (i.e., M₀=2) may be detected in a first GF-PUSCH resource (ID 0), 1 DM-RS (i.e., M₁=1) may be detected in a second GF-PUSCH resource (ID 1), 0 DM-RS (i.e., M₂=0) may be detected in a third GF-PUSCH resource (ID 2), and 3 DM-RSs (i.e., M₃=3) may be detected in a fourth GF-PUSCH resource (ID 3).

The number Mn of the DM-RS IDs detected in the GF-PUSCH resource corresponding to the GF-PUSCH resource ID n may be expressed by 0.3 bits, and the DM-RS ID corresponding to each GF-PUSCH resource ID may also be expressed by 3 bits. Here, 3 may mean [log₂ M].

The bit string may include several [U0 U1 U2] depending on the number Mn of the DM-RS IDs detected in the GF-PUSCH resource. The GF-PUSCH resource ID may be implicitly represented by generating the bit string through the concatenation in the order of GF-PUSCH resource IDs.

FIG. 7 is a conceptual diagram for explaining an example of a first method for representing a group HARQ-ACK.

Referring to FIG. 7, a group HARQ-ACK payload may include a GF-PUSCH resource ID and the number of DM-RS IDs detected for each GF-PUSCH resource. For convenience, the detected DM-RS IDs may be represented as A, B, C, E {0, 1, . . . , [log₂ M]−1}. Also, it may be assumed that 2 bits are allocated to represent 4 GF-PUSCH resource IDs.

Thus, information for the GF-PUSCH resource ID 0 may correspond to {[00][010][A B]}, information for the GF-PUSCH resource ID 1 may correspond to {[01][001][C]}, information for the GF-PUSCH resource ID 2 may correspond to {[10][000]} (i.e., the number of detected DM-RS IDs is 0), and information for the GF-PUSCH resource ID 3 may correspond to {[11][011][D E F]}. On the other hand, the information for the GF-PUSCH resource ID 2 may not be configured. The bit string ({[00][010][A B]}{[01][001][C]}{[11][011][D E F]}) may be obtained by sequentially concatenating these information (i.e., when the information for the GF-PUSCH resource ID 2 is not configured).

This may mean that the number of detected DM-RS IDs is represented by [log₂ Mₙ] bits, and the length of the entire payload may be increased in proportion to the number of bits. The serving base station may further allocate dummy bits (i.e., padding bits) to the payload according to an aggregation level applied to the PDCCH to adjust the required size.

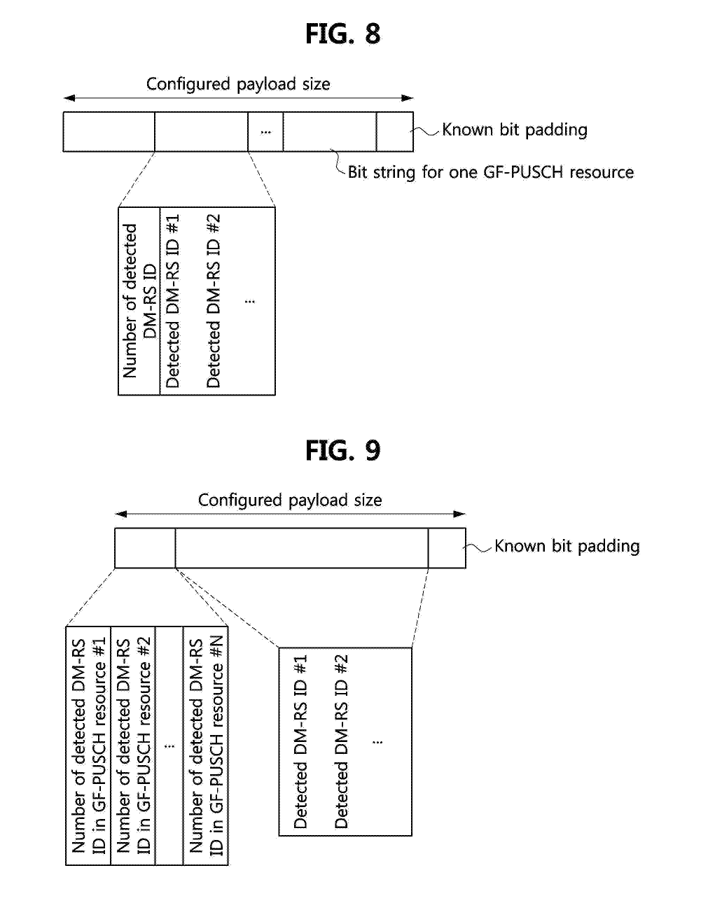

FIG. 8 is a conceptual diagram for explaining another example of a first method for representing a group HARQ-ACK.

Referring to FIG. 8, a group HARQ-ACK payload may not include a GF-PUSCH resource ID for each GF-PUSCH resource, and include the numbers of DM-RS IDs detected in the respective GF-PUSCH resources as they are concatenated in the payload.

Assuming again the case described in FIG. 7, information for the GF-PUSCH resource ID 0 may correspond to {[010][A B]}, information for the GF-PUSCH resource ID 1 may correspond to {[001][C]}, information for the GF-PUSCH resource ID 2 may correspond to {[000]} (i.e., the number of detected DM-RS IDs is 0), and information for the GF-PUSCH resource ID 3 may correspond to {[011][D E F]}. The bit string ({[010][A B]}{[001][C]}{[000]}{[011][D E F]}) may be obtained by sequentially concatenating these information. Since the GF-PUSCH resource ID is not included, even when the DM-RS is not detected in a specific GF-PUSCH resource, information indicating this should be explicitly included in the payload. For example, {[000]} for the GF-PUSCH resource ID 2 indicates that the DM-RS ID is not detected in the GF PSUCH resource corresponding to the GF-PUSCH resource ID 2.

FIG. 9 is a conceptual diagram for explaining yet another example of a first method for representing a group HARQ-ACK.

Referring to FIG. 9, a group HARQ-ACK may not include a GF-PUSCH resource ID for each GF-PUSCH resource, and a front part of the payload may include information on the numbers of DM-RS IDs detected in the respective GF-PUSCH resources.

As yet another example, information on the numbers of DM-RS IDs detected in the respective detected GF-PUSCH resources may be located in a front part of the bit string. For example, the bit string may be represented as ({[010][001][000][011]}{[A B][C][D E F]}).

Similarly to the case of FIG. 8, since the GF-PUSCH resource ID is not included, even when the DM-RS is not detected in a specific GF-PUSCH resource, information indicating this should be explicitly included in the payload. For example, {[000]} for the GF-PUSCH resource ID 2 indicates that the DM-RS ID is not detected in the GF PSUCH resource corresponding to the GF-PUSCH resource ID 2.

### \textcircled{2} Second Example

A second example corresponds to a case where the size of the DCI is variable. In order to prevent a coding rate of the DCI from changing even when the number of DM-RSs detected by the serving base station changes, known bits (e.g., 0 or 1) may be added to a bit string smaller than the maximum length, so that the UE may know in advance the coding rate of the DCI (i.e., the fixed code rate).

The serving base station may not be able to distinguish a plurality of DM-RS IDs in the same GF-PUSCH resource due to the capability of the base station, such as the number of receiving antennas is small or the advanced receiver is not used. Alternatively, the serving base station may limit the maximum value of Mn in order to adjust the payload size of the PDCCH. The value of Mn may be adjusted by the serving base station and configured to the UE through the RRC signaling.

In this case, the number Mn of the DM-RS IDs belonging to the same GF-PUSCH resource ID may be expressed using a smaller number of bits (e.g., 2 bits). In this case, the number of bits may be saved in proportion to the number of GF-PUSCH resource IDs. Compared with the case of the first example, the payload size may be reduced by 1 bit for each GF-PUSCH resource ID.

When a case where a maximum of 3 DM-RS IDs (0<=Mn<=3) can be detected for each GF-PUSCH resource ID is considered, Mn may be represented by 2 bits in order to represent 0, 1, and 2.

A case where 0 DM-RS ID (i.e., M₀=0) is detected in the GF-PUSCH resource ID 0, 1 DM-RS ID (i.e., M₁=1) is detected in the GF-PUSCH resource ID 1, 2 DM-RS IDs (i.e., M₂=2) are detected in the GF-PUSCH resource ID 2, and 3 DM-RS IDs (i.e., M₃=3) are detected in the GF-PUSCH resource ID 3 may be considered. In this case, the bit string obtained by the serving base station may correspond to ({[00]}{[01][A]}{[10][B C]}{[11][D E F]}) (i.e., the case when the method described in FIG. 8 is used). Also, as another method of configuring the bit string, information on the numbers of detected DM-RS IDs may be located first. In this case, the bit string may be represented as ({[00][01][10][11]}{[A][B C][D E F]}) (i.e., the case when the method described in FIG. 9 is used).

If a case where at most one DM-RS ID can be detected for each GF-PUSCH resource ID (Mn=0 or 1) is assumed, the serving base station may encode Mn by using only 1 bit in the PDCCH. A case where 0 DM-RS ID (i.e., M₀=0) is detected in the GF-PUSCH resource ID 0, 1 DM-RS ID (i.e., M₁=1) is detected in the GF-PUSCH resource ID 1, 0 DM-RS ID (i.e., M₂=0) is detected in the GF-PUSCH resource ID 2, and 1 DM-RS ID (i.e., M₃=1) is detected in the GF-PUSCH resource ID 3 may be considered. In this case, the bit string obtained by the serving base station may correspond to ({[1][A]}{[1][B]}{[0]}{[1][C]}) (i.e., the case when the method described in FIG. 8 is used). Also, as another method of configuring the bit string, information on the numbers of detected DM-RS IDs may be located first. In this case, the bit string may be represented as ({[1][1][0][1]}{[A][B][C]}) (i.e., the case when the method described in FIG. 9 is used).

### \textcircled{3} Third Example

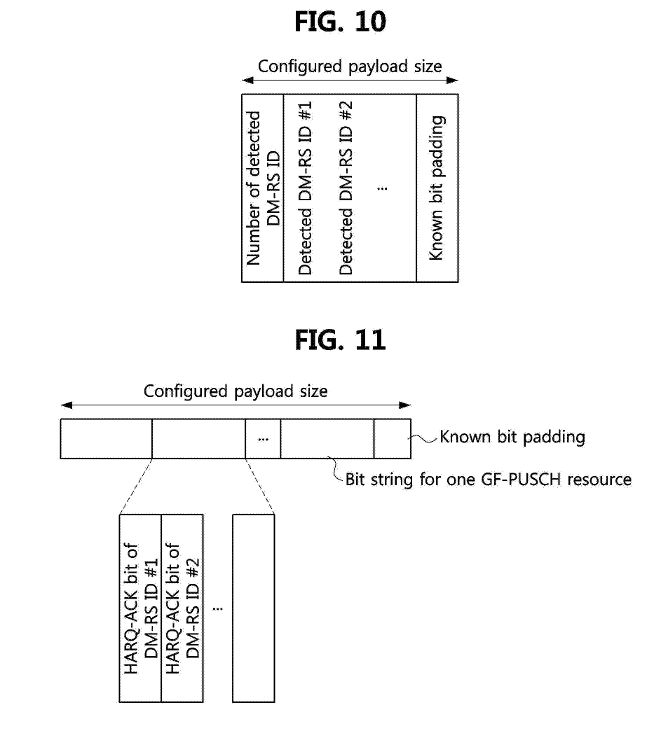

FIG. 10 is a conceptual diagram for explaining a method of transmitting a DCI for each GF-PUSCH resource.

Referring to FIG. 10, the serving base station may generate a bit string for each GF-PUSCH resource and map the generated bit string to a PDCCH as DCI. The UEs transmitting GF-PUSCHs in the same GF-PUSCH resource may be allocated the same scrambling ID, and the UE may monitor only the DM-RS ID or a value derived from the DM-RS ID in the same bit string. In this case, information on the GF-PUSCH resource ID (the explicit GF-PUSCH resource ID or the information according to the order of the GF-PUSCH resource IDs) may not be included in the bit string, unlike the first and second examples described above. When at most Mn DM-RS IDs can be detected in each GF-PUSCH resource, the number of detected DM-RS IDs may be represented by using [log₂ Mₙ] bits.

If a case where at most one DM-RS ID can be detected for each GF-PUSCH resource ID (Mn=0 or 1) is assumed, the serving base station may configure the bit string by including only the detected DM-RS ID. In this case, if the serving BS fails to detect the DM-RS ID, the serving base station may not transmit the PDCCH.

The UE may detect a required PDCCH and DCI using a scrambling ID configured from the serving base station or a scrambling ID derived from a parameter configured from the serving base station, and may obtain a DM-RS ID based on the detected PDCCH and DCI. If the UE does not detect the required PDCCH and DCI, the UE may retransmit the TB to the serving base station.

In order to prevent a coding rate of the DCI from changing even when the number of DM-RSs detected by the serving base station changes, known bits (e.g., 0 or 1) may be added to the bit string smaller than the maximum length, so that the UE may know in advance the coding rate of the DCI (i.e., the fixed code rate).

(2) Method of Using a Bitmap (PHICH Based Approach)

The PDCCH may represent the DM-RS IDs and the GF-PUSCH resource IDs detected by the serving base station by a bitmap composed of N×M bits. According to a position and value of one bit, the UE may identify which DM-RS ID is detected in a GF-PUSCH resource corresponding to a specific GF-PUSCH resource ID. The serving base station may generate the PDCCH through appropriate channel coding and modulation for the bitmap. Alternatively, the serving base station may generate the PDCCH only through modulation without performing channel coding on the bitmap.

### \textcircled{1} First Example

FIG. 11 is a conceptual diagram for explaining an example of a second method for representing a group HARQ-ACK.

Referring to FIG. 11, a case where a bitmap is transmitted for the group HARQ-ACK is illustrated.

A case where 8 DM-RS IDs (i.e., M=8) are allocated for 4 GF-PUSCH resources (i.e., N=4) may be considered. In this case, a bitmap consisting of M bits for each GF-PUSCH resource ID may be required. In the bitmap, the position of ‘1’ may indicate the detected DM-RS ID, and the number of ‘1’s may indicate the number of DM-RS IDs detected for the OF PUSCH resource ID.

For example, a case where 2 DM-RS IDs (i.e., M₀=2) are detected in the GF-PUSCH resource ID 0, 1 DM-RS ID (i.e., M₁=1) is detected in the GF-PUSCH resource ID 1, 0 DM-RS ID (i.e., M₂=0) is detected in the GF-PUSCH resource ID 2, and 3 DM-RS IDs (i.e., M₃=3) are detected in the GF-PUSCH resource ID 3 may be considered. For convenience, it may be assumed that the detected DM-RS IDs may be indicated from a least significant bit (LSB).

A bitmap (0000 0011) may correspond to the GF-PUSCH resource ID 0, a bitmap (0000 0001) may correspond to the GF-PUSCH resource ID 1, a bitmap (0000 0000) may correspond to the GF-PUSCH resource ID 2, and a bitmap (0000 0111) may correspond to the GF-PUSCH resource ID 3.

By the concatenating these bitmaps, an entire bitmap ([0000 0011][0000 0001][0000 0000][0000 0111]) may be obtained. The serving base station may add dummy bits to the obtained bitmap in order to adjust the size of the bitmap to the described size according to a coding rate applied to the PDCCH. This method has an advantage of being able to indicate not only ACK but also NACK or DTx since one bit is allocated to one DM-RS ID.

### \textcircled{2} Second Example

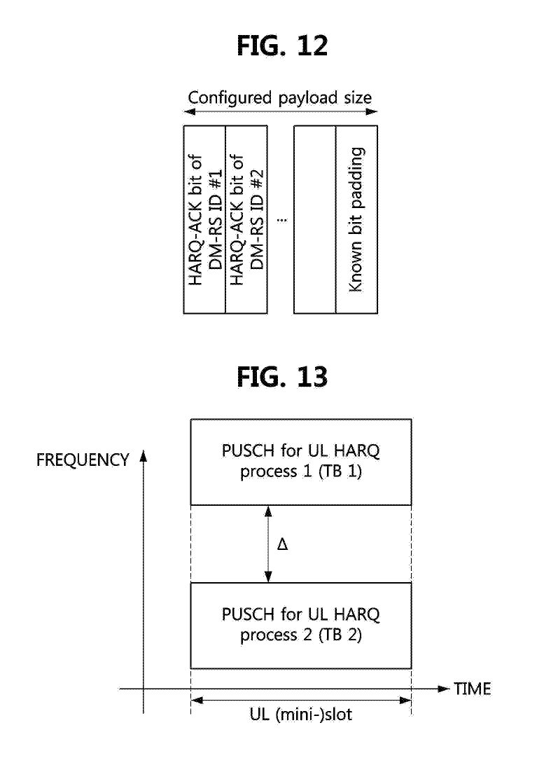

FIG. 12 is a conceptual diagram for explaining another example of a second method for representing a group HARQ-ACK.

The serving base station may generate a bitmap for each GF-PUSCH resource and map the generated bitmap to a PDCCH. The UEs transmitting GF-PUSCHs in the same GF-PUSCH resource may be allocated the same scrambling ID, and the UE may monitor only the DM-RS ID in the same bit string. In this case, unlike the example of FIG. 11, information on the GF-PUSCH resource ID (the explicit GF-PUSCH resource ID or the implicit information according to the order of the GF-PUSCH resource IDs) may not be included in the bitmap. Therefore, the PDCCH may use only M bits without using N×M bits. The serving base station may add dummy bits to the bitmap according to a coding rate applied to the PDCCH to adjust the required size.

Method for Supporting Multiple UL HARQ Processes

It may be assumed that the serving base station configures information required for the GF-PUSCH transmission to the UE through the RRC signaling. Among the information that the serving base station configures to the UE through the RRC signaling, the TB size may be fixed to one, but it may be configured to have two or more values. Considering a higher layer configuration allowing the TB size to have more than 2 values, the information that the serving base station configures to the UE through the RRC signaling for the GF-PUSCH transmission may include information on the GF-PUSCH resource that the UE can select according to the TB size. Here, the definition of the GF-PUSCH resource follows the definition described above.

For example, when the TB size is A1 bytes, the UE may select the GF-PUSCH resource ID 1, and when the TB size is A2 bytes, the UE may select the GF-PUSCH resource ID 2. As another example, when the TB size is equal to or less than A1 bytes, the UE may select the GF-PUSCH resource ID 1, and when the TB size is greater than A1 bytes but less than or equal to A2 bytes, the UE may select the GF-PUSCH resource ID 2. The method may be applied similarly when there are 3 or more reference values for the TB size.

When the UE repeatedly transmits a TB1 K times through the GF-PUSCH transmission, and the serving base station detects a GF-PUSCH DM-RS ID assigned to the UE, but fails to decode the TB1 (i.e., the state 2 in FIG. 5), the serving base station may cause the UE to retransmit the TB1 by using a GB-PUSCH. In this case, the UE may operate only one HARQ process for the GF-PUSCH in order to transmit a TB2 generated newly due to an additional UL traffic.

If the UE repeatedly transmits the TB1 K times through the GF-PUSCH transmission, but the serving base station does not detect the GF-PUSCH DM-RS ID (the state 1 in FIG. 5), since the serving base station cannot know whether or not the UE has transmitted the TB1, the serving base station may not know the presence of the TB1. Therefore, in order to transmit the newly-generated TB2 due to the additional UL traffic, the UE should operate 2 HARQ processes for the GF-PUSCH transmission. Here, a UL HARQ process 1 may be defined for the TB1, and a UL HARQ process 2 may be defined for the TB2.

Hereinafter, a case where 2 UL HARQ processes for the GF-PUSCH transmission are operated and a case where only a single UL HARQ process for the GF-PUSCH transmission is operated will be described.

(1) A Method of Using 2 UL HARQ Processes for GF-PUSCH Transmissions

A case, in which the UE repeatedly transmits the TB1 k (k<K) times through the GF-PUSCH transmission; the serving base station cannot detect a GF-PUSCH DM-RS ID, and the TB2 should be transmitted due to the additional occurrence of the UL traffic, may be considered (e.g., the state 1 of FIG. 5). Therefore, the serving base station does not know the presence of the TB1.

FIG. 13 is a conceptual diagram for explaining a case of operating 2 UL HARQ processes for GF-PUSCH transmission.

Referring to FIG. 13, when sufficient transmission power can be allocated to the UE, the UE may transmit both the TB1 and the TB2. In this case, the UE may simultaneously transmit the TB1 and the TB2 in (K−k) UL slots or minislots, and then transmit the TB2 in k subsequent UL slots or minislots.

For this; the UE may transmit a GF-PUSCH 1 including the TB1 and a GF-PUSCH 2 including the TB2 by using two GF-PUSCH resources. In an equivalent representation, the UE may perform the GF-PUSCH transmission and support 2 UL HARQ processes. In this case, an effect through multi-cluster transmission or distributed allocation of UL PRBs may be obtained.

Since an inter modulation distortion (IMD) and a peak-to-average power ratio (PAPR) increase when the UE transmits 2 HARQ processes at the same time using a distributed PRB allocation, it may be preferable to select GF-PUSCH resources such that a frequency difference (Δ in FIG. 13) between the GF-PUSCH 1 for transmitting the TB1 and the GF-PUSCH 2 for transmitting the TB2 becomes not large. In the case that the UE sets Δ to 0, the transmission of the GF PUSCH may correspond to a localized PRB allocation, thereby further mitigating the IMD problem.

The serving base station may independently decode the TB1 and the TB2 by using the GF-PUSCH resources, and may separately transmit a DL HARQ-ACK to the UE when necessary.

(2) A Method of Using a Single UL HARQ Process for GF-PUSCH Transmissions

On the other hand, if the serving base station is in the state 1 of FIG. 5 and a new UL traffic has occurred but a sufficient transmission power cannot be allocated to the UE, the UE may not transmit the TB1 and the TB2 in the same UL slot or minislot. In this case, since the serving base station does not yet know the presence of the TB1, the UE may re-encode (i.e., aggregate) the TB1 and the TB2 into one TB. For example, the UE may include a type of header in the payload, through which the presence of the TB1 and the TB2 and the sizes of the TB1 and the TB2 can be identified, so that the serving base station can distinguish the TB1 from the TB2 after decoding. Alternatively, the UE may discard the existing TB1 and create a new TB3 based on the traffic of the TB1 and the new traffic.

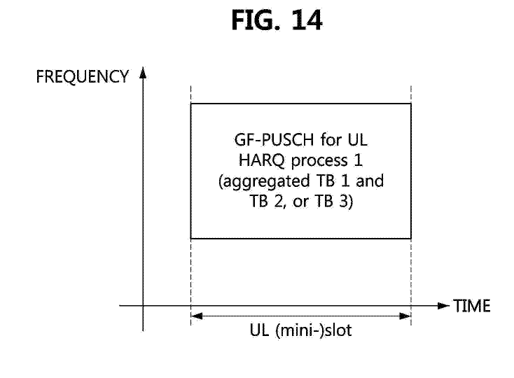

As described above, a case of re-encoding the TB1 and the TB2 into one TB and transmitting the same, and a case of re-encoding the traffics to a new TB3 and transmitting the TB3 are shown in FIG. 14.

FIG. 14 is a conceptual diagram for explaining a case of operating only one UL HARQ process for GF-PUSCH transmission.

Referring to FIG. 14, the TB into which the TB1 and the TB2 are re-encoded or the TB3 occupies more resources since the size is increased. The UE may reselect a GF-PUSCH resource to initiate K repetitive transmissions for transmitting the increased TB. In this case, the UE may reset a repetition counter for the TB1 and start a repetition counter for the TB3.

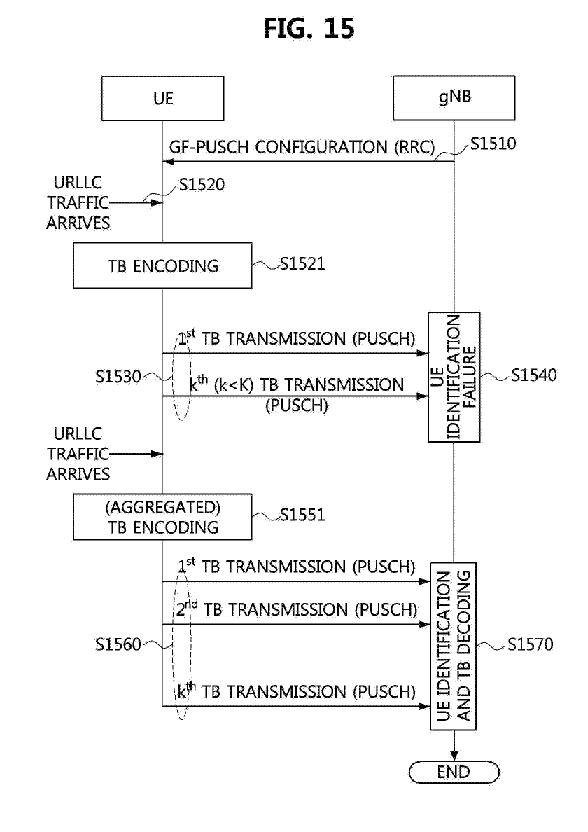

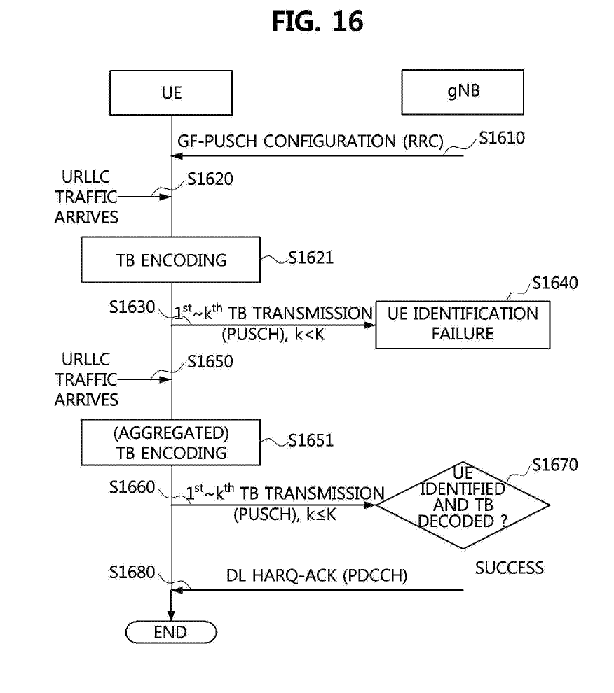

FIGS. 15 and 16 are sequence charts for explaining a case of operating only one HARQ process for GF-PUSCH transmission for which K repetitive transmissions are configured.

As described above, in the case of re-encoding the TB1 and the TB2 to generate one TB or in the case of generating the new TB3, FIG. 15 illustrates a case where early termination is not applied, and FIG. 16 illustrates a case where early termination is applied.

Referring to FIG. 15, the serving base station may configure the UE to perform K repetitive transmissions as the GF-PUSCH transmission (S1510). When a UL traffic arrives (S1520), the UE may encode a TB (i.e., TB1) (S1521) and repeatedly transmit a GF-PUSCH including the TB1 k (k<K) times (S1530). Meanwhile, the serving base station may perform UE identification (DM-RS ID identification) on the GF-PUSCHs transmitted by the UE but may fail (i.e., the state 1 in FIG. 5).

When another UL traffic arrives at the UE after k GF-PUSCH transmissions (S1550), the UE may encode another UL traffic to a TB (i.e., TB2) and re-encode it and the TB1 into one TB, or discard the already encoded TB1 and re-encode the traffic having arrived in the step S1520 and the traffic having arrived in the step S1550 to a new TB3 (S1551).

The UE may repeatedly transmit the re-encoded TB (the TB into which the TB1 and the TB2 are aggregated or the TB3) K times as the GF-PUSCH transmission (S1560), and the serving base station may perform UE identification (DM-RS ID identification) and TB decoding on the GF-PUSCHs repeatedly transmitted by the UE (S1570).

Referring to FIG. 16, the steps S1610 to S1651 may be configured in the same manner as the steps S1510 to S1551 of FIG. 15. However, there is a difference in the step S1671 in which a DL HARQ-ACK is transmitted to the UE for early termination when the serving base station succeeds in the UE identification and the TB decoding through the k (k<K) GF-PUSCH repetitive transmissions (S1670).

(3) A Method of Using a HARQ Process for GB-PUSCH Transmission and a HARQ Process for GF-PUSCH Transmission

When the serving base station detects the GF-PUSCH DM-RS ID but fails to decode the TB1 (i.e., the state 2 in FIG. 5), the serving base station may control the UE to transmit the TB1 as a GB-PUSCH without further transmitting the TB1 as the GF-PUSCH. Meanwhile, while the serving base station transmits a UL grant to the UE for the GB-PUSCH transmission of the UE, a new UL traffic may further occur, so that the UE may start a GF-PUSCH transmission for the TB2.

When the UE has sufficient transmission power, the UE may transmit the TB1 as a GB-PUSCH using the UL HARQ process 1, and transmit the TB2 as a. GF-PUSCH using the UL HARQ process 2 in the same UL slot or minislot. This case may correspond to the case of FIG. 13 described above. On the other hand, when the transmission power to the UE is insufficient, the UE may support only one UL HARQ process. In this case, since the serving base station knows the presence of the TB1 but does not yet know the presence of the TB2, if the UE transmits the TB1 as the GB-PUSCH according to the UL grant, the UE may transmit the TB2 while transmitting the TB1. Therefore, the UE may transmit the GF-PUSCH including the TB2 and the GB-PUSCH including the TB1 repeatedly k (k<K) times and then transmit the GF-PUSCH including the TB2 repeatedly remaining (K-k) times.

Alternatively, since the serving base station does not know the presence of the TB2 in the state 1 of FIG. 5 with respect to the TB2, the UE may repeatedly transmit the GF-PUSCH including the TB2 not (K−k) times but K times. This case may correspond to an operation of the UE which initializes the repetition counter for the TB2.

OOK Based PUCCH Transmission Method

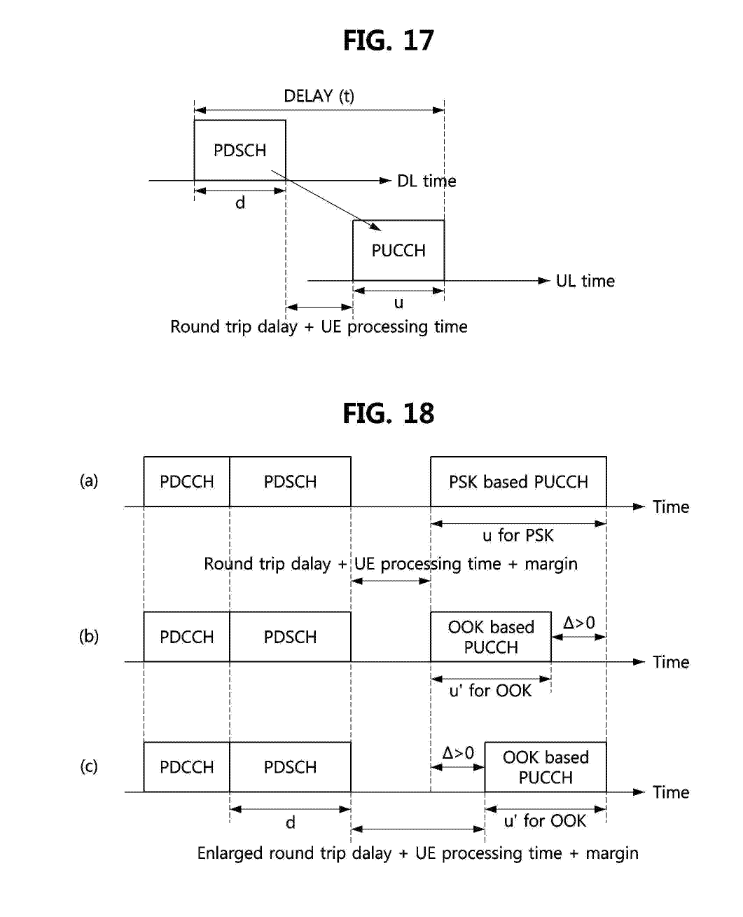

FIG. 17 is a conceptual diagram for explaining factors constituting a time budget required for a serving base station to transmit a PDSCH and receive a PUCCH.

In order to support a DL URLLC traffic, a scheme, in which a serving base station transmits a PDSCH in a slot or a minislot, and a UE transmits a PUCCH in the same slot or minislot by controlling a HARQ processing timeline, may be considered. For example, in a TDD environment, at least one. DL symbol may be allocated in a front part of a slot, and at least one UL symbol may be allocated after guard symbol(s) in the slot. A self-contained slot, in which the symbol(s) through which the PDSCH is transmitted and the symbol(s) through which the PUCCH is transmitted are allocated, may be constructed to quickly perform a UL HARQ-ACK feedback for the PDSCH.

Referring to FIG. 17, for convenience of explanation, it is assumed that the number of symbols through which the PUCCH is transmitted is u, and the number of symbols through which the PDSCH is transmitted is d. For example, the UE may transmit a short duration PUCCH (u=1 or 2) or a long duration PUCCH (u=4, 5, 6, 7, . . . , or 14). The serving base station may obtain a sufficient detection probability for a HARQ-ACK using the short duration PUCCH. When the UE transmits the long duration PUCCH, the serving base station may obtain a higher detection probability, but it is preferable to minimize u because a delay time t is further increased.

On the other hand, d may be determined by the serving base station. As in the case of u, if d is small, a decoding failure probability of the TB at the UE may increase, but the delay time t may decrease. However, since the serving base station is free from the limitation of the transmission power as compared to the UE, the value of d may be adjusted in a wider range.

That is, the serving base station may increase the reliability by optimizing the PDSCH by using sufficiently high power or a wide bandwidth, but the UL HARQ-ACK (PUCCH) transmitted by the UE may not have reliability. This is because the power allocated to the transmission by the UE is limited. Therefore, in order to obtain a sufficient reliability, it is preferable that the UE transmits HARQ-ACK bits by repetition or spreading. This approach has the disadvantage that u increases and thus t increases. Therefore, the serving base station should appropriately distribute a necessary delay time to the DL and the UL according to the link budget of the UE. The values of (d, u) for satisfying a required delay time of the DL URLLC is affected by the round trip delay (or, the propagation delay of the serving base station and the UE). The value of (d+u) should be smaller the longer the round trip delay. Therefore, in order to obtain the same delay time t, when the UE is at the cell center, the delay time condition may be satisfied even if the value of (d+u) is large, but when the UE is at the cell edge, the value of (d+u) should be small. As described above, although the serving base station may reduce d, it is difficult for the UE located at the cell edge to reduce u. Therefore, proposed is a method to sufficiently increase the detection probability of the UL HARQ-ACK even when the value of u is small.

A method of transmitting a UL HARQ-ACK in one bit according to a conventional method will be described. When the UE selects ACK or NACK according to a result of decoding a PDSCH and transmits ACK or NACK through a PUCCH, the serving base station may perform coherent demodulation. If the serving base station can receive the PUCCH corresponding to ACK or NACK in a resource configured to the UE, the serving base station may determine ACK or NACK through the PUCCH. On the other hand, if the serving base station cannot receive the PUCCH or cannot determine ACK or NACK in the resource configured to the UE, the serving base station may determine it as a DTx or a PUCCH detection error and retransmit the corresponding PDSCH to the UE. This method may be easily extended even for a case where a UL HARQ-ACK is composed of several bits. The disadvantage of this method is that there is a minimum signal-to-interference-plus-noise ratio (SINR) of the PUCCH required to determine ACK or NACK because the serving base station performs the coherent demodulation. If the SINR is equal to or less than the minimum SINR, the serving base station cannot determine ACK or NACK through the PUCCH. Therefore, if the serving base station can receive the PUCCH through non-coherent demodulation, the required minimum SINR may be increased.

Therefore, a proposed method may be a method in which separate resources are allocated for the respective HARQ-ACK states, the UE transmits a PUCCH in one of the resources, and the serving base station estimates a HARQ-ACK state by receiving the PUCCH in the resource. Since the serving base station performs a binary hypothesis test on each resource, a lower minimum SINR may be used. Even if u in a phase-shifted keying (PSK) modulation and u′ in an on-off keying (OOK) modulation have the same value (Δ=0 to be described later), the minimum SINR required by the PSK modulation and the minimum SINR required by the OOK modulation are different from each other, the power range of the PUCCH may be adjusted to be wider. This allows a wider range for the same path loss by allowing a larger propagation delay or round trip delay.

That is, the OOK modulation based PUCCH transmission may be applied to an environment having a larger path loss since a higher detection probability can be obtained for the same u value. Therefore, even when the short duration PUCCH having a small u, a wider UL coverage can be obtained, so that the short duration PUCCH can be applied to the UE located at the cell edge.

FIG. 18 is a conceptual diagram for comparing delay times of a PSK modulation based PUCCH and an OOK modulation based PUCCH.

In FIG. 18, a time occupied by the PSK modulation based PUCCH and a time occupied by the OOK modulation based PUCCH are compared with each other. When the UE performs decoding on a PDSCH allocated through a PDCCH, and transmits a PUCCH for the PDSCH, it is more advantageous in terms of delay time to express a HARQ-ACK in the OOK modulation than to express the HARQ-ACK in the PSK modulation. The difference in time may be represented by Δ.

In FIG. 18, a case (a) illustrates the times occupied by d and u when the HARQ-ACK is encoded in the PSK modulation. As compared to this, cases to which a first example and a second example, which will be described later, are applied may be represented as a case (b) and a case (c), respectively. The value of d is identical for the cases, but the difference between u′ when the OOK modulation is applied and u when the PSK modulation is applied may be represented as Δ.

In FIG. 18, the cases (b) and (c) illustrate cases in which the HARQ-ACK is encoded in the OOK modulation. In the cases, assumed is u′ allowing the PSK modulation based PUCCH and the OOK modulation based PUCCH to have the same reception quality at the serving base station. In the case (b), the serving base station may reduce the delay time from transmission of the PDCCH to reception of the PUCCH by Δ. In the case (c), the delay time, may be maintained to be the same as in the case (a) without being decreased by Δ, but the UL coverage can be extended by Δ by allowing the delay time as a margin of the round trip delay.

Meanwhile, the UE may transmit not only the HARQ-ACK but also the SR through the PUCCH. The serving base station may configure PUCCH resources (e.g., time resources, frequency resources, and code resources) for transmission of the SR to the UE through an RRC signaling. After the PUCCH resources for transmission of the HARQ-ACK are configured through the RRC signaling, the UE may select one PUCCH resource by using a DCL Here, a PUCCH for the HARQ-ACK (hereinafter, referred to as ‘HARQ-ACK PUCCH’) and a PUCCH for the SR (hereinafter, referred tows ‘SR PUCCH)’ may use different PUCCH resources.

Generally, the number of symbols of the SR PUCCH and the number of symbols of the HARQ-ACK PUCCH may be different from each other, and the starting symbol indexes for them may also be different. When the starting symbol indexes are equal to each other in the same slot, the UE may transmit the SR PUCCH and HARQ-ACK PUCCH in one PUCCH even if the numbers of symbols are different. However, since it takes a smaller time to generate the SR PUCCH than a time required for decoding the PDSCH and generating the HARQ-ACK PUCCH in response to the PDSCH, it may be inefficient to determine whether or not the SR and the HARQ-ACK are multiplexed based on only the starting symbol indexes. In order to improve this, when the UE transmits the SR PUCCH and the HARQ-ACK PUCCH in the same slot, the SR PUCCH and the HARQ-ACK PUCCH may be transmitted as one PUCCH even if the numbers of symbols or the starting symbol indexes are different from each other. The PUCCH applied here may correspond to the HARQ-ACK PUCCH, and the resource of the SR PUCCH may not be used. Since the serving base station knows in advance how many HARQ-ACK bits the UE should process, the serving base station may configure a resource set to the UE through the RRC signaling. The UE may select one PUCCH resource belonging to the resource set by using the DCI. This is not related to the PUCCH resource for transmitting the SR.

In the case that the UE needs to transmit the HARQ-ACK and the SR for the URLLC PDSCH at the same time, the UE should multiplex them. Therefore, when the PUCCH is transmitted in the slot in which the SR can be transmitted, a frequency resource used for a positive SR and a frequency resource for a negative SR may be configured differently. In order for the UE to transmit n bits of the HARQ-ACK and the SR, the UE should transmit (n+1) bits of uplink control information (UCI), and thus 2ⁿ⁺¹ resources may be configured to the UE through the RRC signaling.

Since 2ⁿ resources are required to transmit n bits through the PUCCH, the serving base station may configure the UE to perform a HARQ-ACK bundling through the RRC signaling. In this case, the UE may compress n bits to 1 bit using a logical AND operation, and may map 1 bit to at least one resource element (RE) in the PUCCH. If the PUCCH is transmitted in the same slot as the SR, it may be regarded as a UCI of 2 bits, and 4 or less resources may be configured to the UE through the RRC signaling.

### \textcircled{1} First Example

The HARQ-ACK state for the URLLC PDSCH is classified into ACK and NACK. When n TBs correspond to the URLLC, the HARQ-ACK may be represented by n bits. Thus, the serving base station may configure 2ⁿ resources to the UE through the RRC signaling. The UE may select one of the 2ⁿ resources according to a decoding result of the TBs, and transmit the PUCCH by using the selected resource. The UE may process NACK and DTx as one state. Since 3″ resources should be configured to the UE if ACK, NACK, and DTx are all distinguished separately, it may not be preferable to process NACK and DTX as separate states.

The serving base station may perform binary hypothesis tests on 2ⁿ resources and detect the PUCCH in one resource. Through this, the serving base station may determine which TBs are in the ACK state and which TBs are in the NACK state. If the serving base station does not detect any energy in 2ⁿ resources, the serving base station may determine that all TBs are in the NACK state or the DTx state.

In the slot in which the SR and the HARQ-ACK should be transmitted at the same time, the UE may select one resource among 2ⁿ⁺¹ resources according to the SR and the HARQ-ACK, and transmit the PUCCH through the selected resource. Through this, the serving base station may know the values of the SR and the HARQ-ACK.

If n=1, the serving base station may configure 2 resources to the UE through the RRC signaling. Each may correspond to a resource through which a PUCCH for the ACK is transmitted or a resource through which a PUCCH for the NACK is transmitted. The UE may select one resource, and transmit the PUCCH to the serving base station in the selected resource. The serving base station may attempt to detect the PUCCH in 2 resources. If the serving base station detects the PUCCH in one resource, the serving base station may determine ACK or NACK accordingly. If the PUCCH is not detected in both of 2 resources, the serving base station may determine that the UE is in the DTx state. In the slot in which the SR and the HARQ-ACK should be transmitted simultaneously, the UE may select one resource among 4 (i.e., 2^{l+1}) resources according to the SR and the HARQ-ACK, and transmit the PUCCH in the selected resource.

### \textcircled{2} Second Example

The HARQ-ACK state for the URLLC PDSCH may be classified into an ACK state and a state other than the ACK state. When n TBs correspond to the URLLC, the HARQ-ACK may be represented by n bits. The UE may not transmit the PUCCH if all TBs are in the NACK state or the DTX state. Therefore, except this one case, the serving base station may set 2ⁿ−1 resources to the UE through the RRC signaling. The UE may select one of the 2ⁿ−1 resources according to a decoding result of the TBs, and transmit the PUCCH in the selected resource. The serving base station may perform binary hypothesis tests on 2ⁿ−1 resources and demodulate the PUCCH in the resource selected by the UE. Through this, the serving base station may determine which TBs are in the ACK state and which TBs are in the NACK state. If the serving base station does not detect any energy in 2ⁿ−1 resources, the serving base station may determine that all TBs are in the NACK state or the DTx state.

In the slot in which the SR and the HARQ-ACK should be transmitted at the same time, the UE may select one resource among 2ⁿ⁺¹−1 resources according to the SR and the HARQ-ACK, and transmit the PUCCH through the selected resource. The UE may exclude a case where the values of all HARQ-ACKs indicate NACK or DTX and the SR is a negative SR.

If n=1, the serving base station may configure one resource to the UE through the RRC signaling. This may correspond to a resource through which a PUCCH for the ACK is transmitted. The UE may notify the ACK by transmitting the PUCCH to the serving base station in the resource, or notify the NACK or the DTx by not transmitting the PUCCH in the resource. In the slot in which the SR and the HARQ-ACK should be transmitted simultaneously, the UE may select one among 3 resources according to the SR and the HARQ-ACK, and transmit the PUCCH in the selected resource. The 3 resources may correspond to a (ACK+positive SR), a (NACK+positive SR), and a (ACK+negative SR), respectively.

Resource Allocation for SR

A case where a UL URLLC traffic is generated and the UE transmits an SR to transmit a GB-PUSCH may be considered. When the UE transmits the SR by applying the frequency diversity scheme, it may be easy for the serving base station to detect the SR when a channel gain is high in some subbands while transmitting the SR in a wider band. However, since the channel gain is low in the remaining subbands, if the UE does not have channel information (i.e., CSI at transmitter (CSIT)), the UE may allocate a part of transmission power only to a subband having a high channel gain. On the other hand, when the UE transmits the SR by applying the time diversity scheme, since the SR is transmitted using a larger number of UL symbols, more time is required to transmit the SR to the serving base station. It may not be preferable to use only the time diversity scheme because a time longer than a coherence time is required to obtain independent fading using the time diversity scheme.

When the UE applies both the time diversity scheme and the frequency diversity scheme, the SR may be transmitted using different subbands in different symbols. Since the channel gains of REs through which the UE transmits the SR are different from each other, if the channel gain of at least one of the subbands is high, the detection probability of the SR received by the serving base station may be high.

When the frequency hopping is disabled for the PUCCH carrying the SR or the short duration PUCCH using only one symbol is used as the PUCCH carrying the SR, it may be preferable to apply a scheme other than the time diversity scheme or the frequency diversity scheme. On the other hand, when the frequency hopping is disabled while the PUCCH carrying the SR uses several symbols, a multiplexing capacity may be increased by using time domain orthogonal cover codes (OCCs) and by increasing the length of the OCCs.

If the UE has a CSIT or a part of the CSIT, the UE may utilize it for the transmission of the SR. As a method of obtaining a part of the CSIT or the CSIT, a method in which the serving base station transmits the CSIT to the UE, or a method in which the serving base station transmits an index of a frequency resource to be used for the SR to the UE may be available. In addition to these methods, a method of implicitly notifying a frequency resource to be used for the SR to the LIE may be considered.

### \textcircled{1} First Example

The serving base station may configure N (≥1) frequency resources available for the SR to the UE through the RRC signaling. Then, the serving base station may notify a CSIT to the UE through a PDSCH. The UE may know which frequency resource channel gain is higher according to the CSIT. When the UE needs to transmit the SR, the UE may select a frequency resource with the highest channel gain among the frequency resources, and transmit the SR in the selected frequency resource. The serving base station may know the frequency resource selected by the UE in advance, and thus may not perform a blind detection. In the case where a channel reciprocity is fully or partially established, the UE may estimate the CSIT using a DL RS even if the serving base station does not transmit the CSIT to the UE, so that the corresponding procedure may be omitted.

### \textcircled{2} Second Example

The serving base station may configure N (≥1) frequency resources available for the SR to the UE through the RRC signaling. Then, the serving base station may inform the UE of an index indicating a frequency resource among the frequency resources. As a method for this, an index may be transmitted using a PDCCH, or an SR resource using a specific frequency resource may be activated or deactivated using a MAC control element (CE). When the UE needs to transmit the SR, the UE may transmit the SR in the SR resource corresponding to the index received from the serving base station or in the SR resource activated by the MAC CE.

When the index of the frequency resource used for transmitting the SR is changed, the serving base station may notify the updated index to the UE using the PDCCH or the MAC CE. For this, the serving base station may transmit a periodic PDCCH or a periodic MAC CE to the UE. Alternatively, in an environment where the mobility of the UE is small, the serving base station may transmit the PDCCH or the MAC CE to the UE only when an event in which the index is updated, without periodically transmitting the PDCCH or the MAC CE. Here, the event may refer to a case where the UE observes the DL CSI and determines that a performance (e.g., SINR, BLER) corresponding to a specific resource index becomes greater than a predetermined threshold value.

The UE may periodically observe such the PDCCH or the MAC CE, and may not observe both of the PDCCH and the MAC CE. The serving base station may indicate the UE by the RRC signaling whether the serving base station informs the UE of the SR resource with the PDCCH or with the MAC CE. Alternatively, the serving base station may use only one of the method of informing the UE of the SR resource via the PDCCH and the method of informing, the UE of the SR resource via the MAC CE. In this case, the RRC signaling may be omitted.

### \textcircled{3} Third Example

The serving base station may configure N (≥1) frequency resources available for the SR to the UE through the RRC signaling. The UE may receive a DL physical layer signal and a DL physical channel from the serving base station, and apply the channel reciprocity to estimate a UL channel response roughly. Based on this, the UE may select one frequency resource used by the SR. Unlike the above-described examples (the first example and the second example), there is an advantage that the signaling overhead is small because the serving base station does not explicitly indicate the frequency resource to the UE. If the serving base station also estimates the UL channel response through a sounding reference signal (SRS) or the like, and knows which frequency resource the UE selects, the serving base station may not perform a blind detection. However, if the serving base station does not trust antenna calibration of the UE, it may be preferable to perform the blind detection on the N frequency resources.

Occasion Based PDSCH/PUCCH/PUSCH Transmission

The serving base station may configure the UE to receive the PDSCH over a plurality of slots through the RRC signaling. For example, the serving base station may configure a DL aggregation factor to allocate resources to the UE so that the UE receives the same TB in one slot, and repeats it in two or more slots.

The UE may receive the PDSCH by applying assignment of the same time domain resource and the same frequency domain resource within the slots during the slots (i.e., PDSCH occasion) corresponding to the DL aggregation factor. In this case, the UE may receive the PDSCH from the resource dynamically allocated by the serving base station using the DL DCI, or may receive the PDSCH from the resource configured by the serving base station using the RRC signaling.

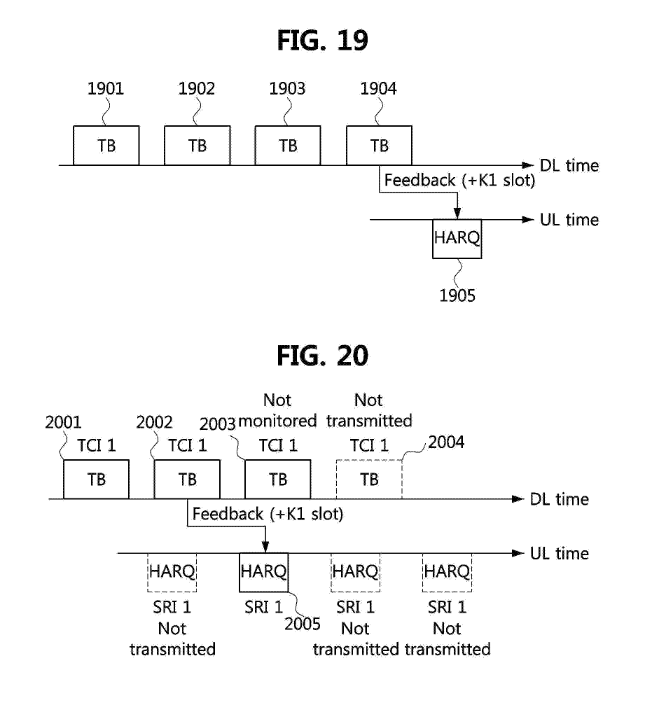

FIG. 19 is a conceptual diagram for explaining a case where PDSCH repetitive transmissions and a HARQ-ACK feedback are performed by a conventional scheme.

Referring to FIG. 19, the serving base station may transmit the PDSCH including the same TB to the UE four times (e.g., 1901 to 1904), and the UE may feedback the HARQ-ACK 1905 for the PDSCH to the serving base station. The timing of the HARQ-ACK feedback may be applied to the last slot (e.g., the slot in which the PDSCH 1904 is received) belonging to the PDSCH occasion as a reference slot for the HARQ-ACK feedback. That is, the feedback 1905 for the PDSCH may be transmitted in the slot after slots indicated by a slot offset K₁ from the last slot (e.g., the slot in which the PDSCH 1904 is received) belonging to the PDSCH occasion.

The PDSCH occasion may consist of one or more PDSCH instances (e.g., 1901 to 1904), and each PDSCH instance may transmit a DL TB. The serving base station may configure the PDSCH occasion to the UE through the RRC signaling. Each PDSCH instance may have the same PRB assignment and the same number of symbols.

In a proposed method, the serving base station may indicate to the UE, through the DL-DCI or the RRC signaling, the number of PDSCH instances included in the PDSCH occasion. Meanwhile, when the DL-DCI indicates the number of PDSCH instances, the serving base station may configure available candidates of the number of PDSCH instances through the RRC signaling, and then select one of the configured candidates by using the DL-DCI.

Configuration of Precoding for PDSCH Instances

The same precoding matrix indicator (PMI) or different PMIs may be applied to the PDSCH instances included in the PDSCH occasion. The serving base station may notify the PMI(s) applied to the PDSCH instances included in the PDSCH occasion to the UE in form of a list by the RRC signaling. When the PDSCH occasion is assumed to include 4 PDSCH instances for convenience of explanation, the list may be configured to have 4 elements indicated by indexes 0, 1, 2, and 3, and each element may be configured to indicate a PMI and the number of layers so that the UE can determine a receiving spatial filter based on the RRC signaling.

In an embodiment, if the serving base station does not provide the list to the UE through the RRC signaling, the UE may assume that the PDSCH instances included in the PDSCH occasion have indexes predefined in the technical specification. As an example, the UE may apply indexes to PDSCH instances in order of (0, 1, 2, 3). This may correspond to a PDSCH sweeping scheme. As another example, the UE may apply indexes to the PDSCH instances in order of (0, 0, 0, 0). This may correspond to a PDSCH repetition scheme. As another example, the UE may apply indexes to the PDSCH instances in order of (0, 2, 0, 2). This may correspond to a partial PDSCH sweeping scheme.

In another embodiment, if the serving base station does not provide the list to the UE through the RRC signaling, the UE may assume that all the PDSCH instances included in the PDSCH occasion have the same index, and apply a PMI (i.e., index) included in the DL-DCI to all the PDSCH instances. For example, when the UE detects an index x in the DL-DCI, the UE may apply the index in the order of (x, x, x, x) to the PDSCH instances of the PDSCH occasion.

In yet another embodiment, the order of the indexes applied to the PDSCH instances of the PDSCH occasion may be defined in the technical specification, and the serving base station may indicate to the UE a starting value of the indexes applied to the PDSCH instances among the predefined indexes in the technical specification by using the DL-DCI. For example, when the specification defines the order a indexes as (x, y, z, w, . . . ), if the DL-DCI indicates the index z to the UE, the UE may apply the indexes to the PDSCH instances in the order of (z, w, . . . ).

In yet another embodiment, the serving base station may configure index vectors to the UE through the RRC signaling. The UE may identify which index vector is to be applied by using a value obtained from the DL-DCI received from the serving base station. For example, the serving base station may configure J (J≥1) index vectors each of which is composed of 4 indexes (a, b, c, d) to the UE through the RRC signaling. The UE may use the j-th index vector among the J index vectors by using a value derived from the DL-DCI received from the serving base station, and identify the indexes applied to the PDSCH instances using the j-th index vector. For example, the index a and the index b may be sequentially applied in the order of the PDSCH instances belonging to the PDSCH occasion. When there are fewer than 4 PDSCH instances, the indexes are applied in the order (e.g., if there are only 3 PDSCH instances, the indexes a, b, and c may be applied). When there are more than 4 PDSCH instances, the index vector may be applied in a cyclic manner so that the index a may be applied after the index d. For convenience of description, it is assumed that the above-described examples have 4 PDSCH instances, but the above-described method may be applied even when the number of PDSCH instances is different.

Configuration of Redundancy Version for PDSCH Instances

The PDSCH instances included in the PDSCH occasion may all have the same redundancy version (RV) or have different RVs.

In an embodiment, if the serving base station does not provide a separate RRC signaling to the UE, the UE may assume that the PDSCH instances included in the PDSCH occasion have RVs predefined in the technical specification. As an example, the UE may apply RVs to PDSCH instances in order of (0, 2, 3, 1). As another example, the UE may apply RVs to the PDSCH instances in order of (0, 0, 0, 0), or the UE may apply RVs to the PDSCH instances in order of (0, 2, 0, 2).

In another embodiment, if the serving base station does not provide the RRC signaling to the UE, the UE may assume that all the PDSCH instances included in the PDSCH occasion have the same RV, and apply an RV included in the DL-DCI to all the PDSCH instances. For example, when the UE detects an RV x in the DL-DCI, the UE may apply the RV in the order of (x, x, x, x) to the PDSCH instances of the PDSCH occasion.

In yet another embodiment, the order of the RVs applied to the PDSCH instances of the PDSCH occasion may be defined in the technical specification, and the serving base station may indicate to the UE a starting value of the RVs applied to the PDSCH instances among the predefined RVs in the technical specification by using the DL-DCI. For example, when the specification defines the order of RVs as (x, y, z, w, . . . ), if the DL-DCI indicates the RV z to the UE, the UE may apply the RVs to the PDSCH instances in the order of (z, w, . . . ).

In yet another embodiment, the serving base station may configure RV vectors to the UE through the RRC signaling. The UE may know which RV vector is to be applied by using a value obtained from the DL-DCI received from the serving, base station. For example, the serving base station may configure J (J≥1) RV vectors each of which is composed of 4 values (RV a, RV b, RV c, RV d) to the UE through the RRC signaling. The UE may use the j-th RV vector among the J RV vectors by using a value derived from the DL-DCI received from the serving base station, and identify the RVs applied to the PDSCH instances using the j-th RV vector. For example, the RV a and the RV b may be sequentially applied in the order of the PDSCH instances belonging to the PDSCH occasion. When there are fewer than 4 PDSCH instances, the RVs are applied in the order (e.g., if there are only 3 PDSCH instances, the RVs a, b, and c may be applied). When there are more than 4 PDSCH instances, the RV vector may be applied in a cyclic manner so that the RV a may be applied after the RV d. For convenience of description, it is assumed that the above-described examples have 4 PDSCH instances, but the above-described method may be applied even when the number of PDSCH instances is different.

Early Termination of PDSCH Occasion

The PDSCH repetitive transmission may be performed in the PDSCH occasion, or the PDSCH sweeping transmission may be performed in the PDSCH occasion. When the UE identifies a PDCCH allocating the same TB, the UE may not newly transmit the PDSCH occasion for it.

In an embodiment, the UE may assume that no new PDCCH occasion (to be described later) is allocated while another PDCCH occasion is already in progress. Since a PDCCH instance included in the PDCCH occasion does not provide a new DL assignment, the UE may no longer need to monitor a PDCCH instance in the PDCCH occasion in which the DL assignment has been already detected.

In another embodiment, the UE may assume that a new PDCCH occasion may be received while another PDCCH occasion is already in progress. That is, a case where 2 or more PDCCH occasions overlap in time may occur. Since the UE can receive a DL assignment for a new DL TB, the UE may continue to monitor PDCCH instances in the new PDCCH occasion even though the UE has already detected the DL assignment in the PDCCH occasion in progress.

(1) PDSCH Repetitive Transmission

In a scenario being considered, it may be assumed that all PDSCH instances belonging to the PDSCH occasion have all the same transmission configuration indication (TCI) state. Since the UE can receive the PDSCH instances multiple times, the UE may perform soft combining to extend a DL coverage.

The UE may be configured to receive K PDSCH instances through the RRC signaling, and may receive the PDSCH instances in K slots. A value of a slot offset K₁ indicating the HARQ feedback timing may be obtained from a DL assignment through which the PDSCH is assigned or from the RRC signaling through which the PDSCH is assigned. In this case, a method of decoding the TB after receiving all the K PDSCH instances, like the conventional method, may cause a delay of (K+K₁) slots. In order to reduce such the delay, the UE may decode the PDSCH in each slot, and derive ACK or a NACK for the PDSCH in each slot. Even when the UE gives an ACK feedback or a NACK feedback derived in each slot to the serving base station in each slot, the serving base station should retransmit the TB if the UE transmits the NACK feedback. However, since the serving base station has not yet completed the transmission of the PDSCH instances, the UE may succeed in decoding the TB in the next PDSCH instance. Therefore, proposed is a method in which the UE does not give the respective HARQ-ACK feedbacks for all the PDSCH instances. This method may have the effect of reducing the PUCCH transmission overhead.

In an embodiment, a HARQ-ACK feedback may be allowed for the PDSCH instance transmitted in a slot other than the last slot belonging to the PDSCH occasion. The slot in which the HARQ-ACK feedback is performed may be the first slot in which the UE has successfully decoded the TB. A resource for transmitting a PUCCH within the slot may be a resource indicated by a PUCCH resource indicator (PRI) transmitted to the UE through the DL-DCI.

The UE may be configured to receive K PDSCH instances through the RRC signaling, and receive the PDSCHs in K slots. When the UE successfully decodes the PDSCH only by receiving k (k<K) times, the UE may transmit the HARQ-ACK in the K₁-th slot from the k-th slot in which the PDSCH is received. A value of the slot offset K₁ indicating the HARQ feedback timing may be obtained from a DL assignment through which the PDSCH is assigned or from the RRC signaling through which the PDSCH is assigned. As illustrated in FIG. 20 to be described later, k may be 2 and K may be 4.

In another embodiment, the UE may transmit the HARQ-ACK only when the HARQ-ACK indicates the ACK. When the serving base station receives the PUCCH for the PDSCH occasion, the serving base station may not transmit a part of the PDSCH occasion to the UE. The UE may transmit the PUCCH if the decoding result of the PDSCH indicates the NACK, but may not transmit the PUCCH if the decoding result of the PDSCH indicates the ACK.

Thereafter, since the UE no longer needs to decode the TBs transmitted in the PDSCH occasion, the UE may not monitor the PDSCH instances transmitted by the serving base station. The serving base station may not transmit the PDSCH after receiving the ACK.

Therefore, in the above embodiment, since it is not necessary to transmit all the K PDSCH instances to the UE, the TB can be transmitted to the UE while using less resources. That is, the UE may interpret the value of K as the maximum number of transmissions of the PDSCH instances without interpreting it as the number of PDSCH instances.

FIG. 20 is a conceptual diagram for explaining an early termination scheme for the PDSCH repetitive transmission.

Referring to FIG. 20, there is shown a case where a PUCCH occasion for transmitting an HARQ-ACK consists of only one instance. The UE may decode the TB from the k-th (k=2) PDSCH instance 2002 in the PDSCH occasion (K=4). The UE may transmit an ACK to the serving base station in the K₁-th slot 2005 from the k-th PDSCH instance 2002 by using the PUCCH. The serving base station may not transmit the PDSCH after decoding the PUCCH. Since the serving base station is before recognizing the ACK transmitted by the UE, the (k+1)-th (i.e., 3^{rd}) PDSCH instance 2003 may be transmitted to the UE, but the UE may not monitor it. On the other hand, the (k+1)-th (i.e., 4^{th}) PDSCH instance 2004 may not be transmitted after the serving base station recognizes the ACK transmitted by the UE, and the UE may not monitor it.

(2) PDSCH Sweeping Transmission

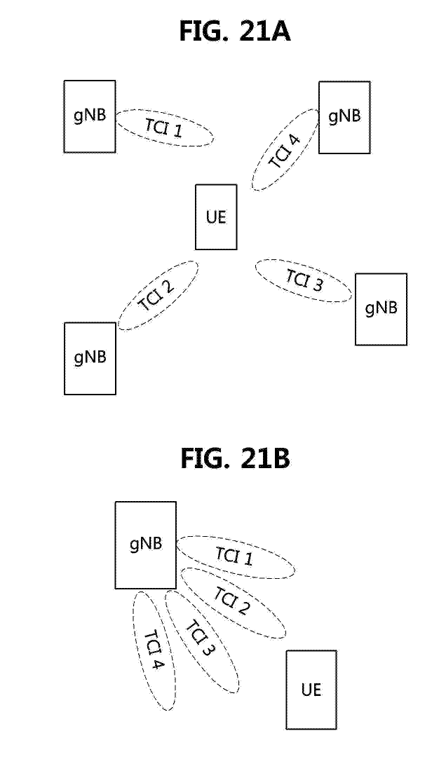

FIGS. 21A and 21B are conceptual diagrams for respectively explaining a beam sweeping using multiple transmission points and a beam sweeping using a single transmission point.

In the above-described examples, the PDSCH instances are assumed to have the same TCI state. However, the above-described methods are not applicable only when assuming the same TCI state. The above-described methods may also be applied even when all the PDSCH instances belonging to the PDSCH occasion have different TCI states or when some PDSCH instances belonging to the PDSCH occasion have different TCI states. These cases may correspond to, rather than the case for extending a DL coverage, a case where the beam sweeping is performed in CoMP scenarios using multiple transmission points (TxPs), a case where the beam sweeping is performed in a single transmission point using a plurality of beams, and the like.

Although the above-described methods assume the same spatial filter for the PUCCH, the above-described methods may not be applied only to the same spatial filter. As in the conventional method, in the methods proposed below, the UE may use a spatial filter indicated by the PRI in the DL-DCI assigning the PDSCH.

In the case that the PDSCH occasion is allocated by one DL-DCI, the TCI states of the PDSCH instances should be known to the UE, and the spatial filters of the PUCCHs corresponding to the PDSCH instances should also be known to the UE. For the PDSCH occasion composed of K PDSCH instances, K TCI states should be defined.

In a proposed method, the serving base station may use the DL-DCI to indicate to the UE the order of the TCI states applied to the PDSCH instances. Alternatively, the serving base station may indicate to the UE the TCI states applied to the PDSCH instances and the order of the TCI states through the RRC signaling. In order to indicate to the UE the order of the TCI states by using the DL-DCI, the serving base station should configure the TCI states to the UE through the RRC signaling.

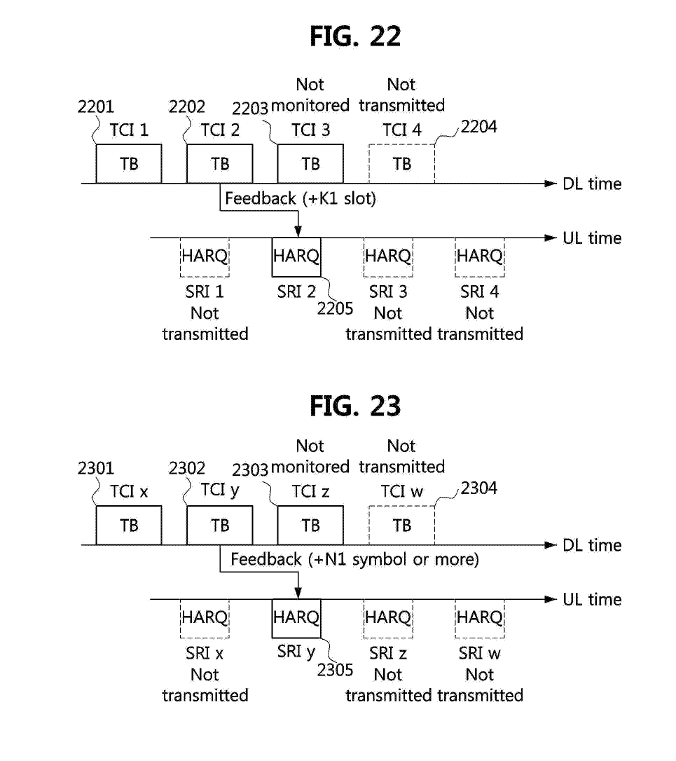

The spatial filter of the PUCCH is associated with the TCI state, and may be configured through the RRC signaling. Therefore, even when receiving the TCI states through the DL-DCI, the UE may know the order of the spatial filters, applied to the PUCCHs only based on the order of the given TCI states. For convenience of explanation, the spatial filter applied to the PUCCH for transmitting the HARQ-ACK is illustrated as being configured using an ‘SRS resource indicator (SRI)’ in FIGS. 22 and 23 which will be described later. However, the embodiments according to the present disclosure are not limited thereto. For example, the serving base station may configure a spatial filter to the UE by using a CSI-RS resource indicator (CRI) or a synchronization signal block (SSB) index.

FIG. 22 is a conceptual diagram for explaining an early termination scheme for the PDSCH sweeping transmission.

Referring to FIG. 22, there is shown a case where a PUCCH occasion for transmitting the HARQ-ACK consists of only one instance. Also, a case in which a PDSCH occasion has K (K=4) TCI states is shown. The above-described methods may be applied. The UE may succeed in decoding of the TB in the k-th (k=2) PDSCH instance 2202, and give the HARQ-ACK feedback through the PUCCH in the K₁-th slot 2205 from the slot in which the k-th PDSCH instance is 2202 transmitted. The UE may determine that the spatial filter of the PUCCH corresponds to the k-th TCI state. The UE may transmit the PUCCH using the k-th SRI. The UE may transmit the PUCCH only when the PUCCH indicates ACK. Thereafter, the serving base station may no longer perform the PDSCH sweeping transmission after recognizing the ACK transmitted by the UE, and the UE may no longer monitor the PDSCH instances.

Method for Determining a HARQ-ACK Feedback Timing

Another method of determining the timing of the HARQ-ACK feedback is proposed.

In the conventional method, the UE may obtain the value of the slot offset K₁ through the DL-DCI or the RRC signaling. However, depending on the capacity of the UE and the size of the TB, the UE may generate the HARQ-ACK earlier than the slot indicated by the value of the signaled K₁. Also, if the candidate values are configured to large values rather than small values in the process of configuring the candidate values for the K₁ through the RRC signaling, it may be difficult to perform optimization in view of performing the HARQ-ACK feedback more quickly.

In an embodiment, the UE may transmit a PUCCH in the next slot occurring after completing decoding of the TB or in the first resource occurring after completing decoding of the TB. For example, when the UE needs a time corresponding to at least N1 symbols for decoding of the PDSCH, the UE may transmit the PUCCH at the first resource occurring after N1 symbols from the last symbol of the corresponding PDSCH.

The serving base station may set whether or not to apply the above-described feedback timing to the UE using the DL-DCI or the RRC signaling.

When the DL-DCI is used, if a specific value is indicated to the UE in a field indicating the HARQ-ACK timing, the UE may give the HARQ-ACK feedback in the first time resource occurring after the decoding of the PDSCH. The UE may determine a resource through which the PUCCH is transmitted according to a resource indicator included in the DL-DCI.

When the RRC signaling is used, if the serving base station configures the HARQ-ACK timing to the UE, the UE may give the HARQ-ACK feedback in the first time resource occurring after the decoding of the PDSCH. The serving base station may configure the HARQ-ACK timing through the RRC signaling, but the resource through which the PUCCH is transmitted may be notified to the UE by using the resource indicator included in the DL-DCL

Here, other resources (e.g., a time resource within slot, a frequency resource within slot, a sequence resource, a spatial resource, etc.) for transmitting the PUCCH may be signaled to the UE by using a PRI in the DL-DCI assigning the PDSCH and/or the RRC signaling.

FIG. 23 is a conceptual diagram for explaining an early termination scheme for the PDSCH occasion.

Referring to FIG. 23, there is shown a case where the HARQ-ACK timing is determined according to the capability of the UE, and the PUCCH occasion for transmitting the HARQ-ACK consists of only one instance. The number of PDSCH instances included in the PDSCH occasion may be set to K via the RRC signaling. In the case of the PDSCH repetitive transmission, the TCI states of the PDSCH instances may be all set to the same (x=y=z=w), and in the case of the PDSCH sweeping transmission, the TCI states of at least some PDSCH instances may be set differently (x≠y≠z≠w). The UE may derive the first time resource available for use by the PUCCH after the UE decodes the TB and the ACK for the TB occurs, and may transmit the HARQ-ACK at the corresponding time resource. After transmitting the PUCCH, the UE may no longer monitor the PDSCH instance. After receiving the ACK, the serving base station may not transmit the PDSCH instance any more.

In the above-described embodiments, the PUCCH is described as being transmitted only once. However, the PUCCH may be configured to be transmitted more than once in the form of the PUCCH occasion including the PUCCH instances. The SRIs of the PUCCH instances belonging to the PUCCH occasion at this time may be the same or different.

PUCCH Occasion Determination Method

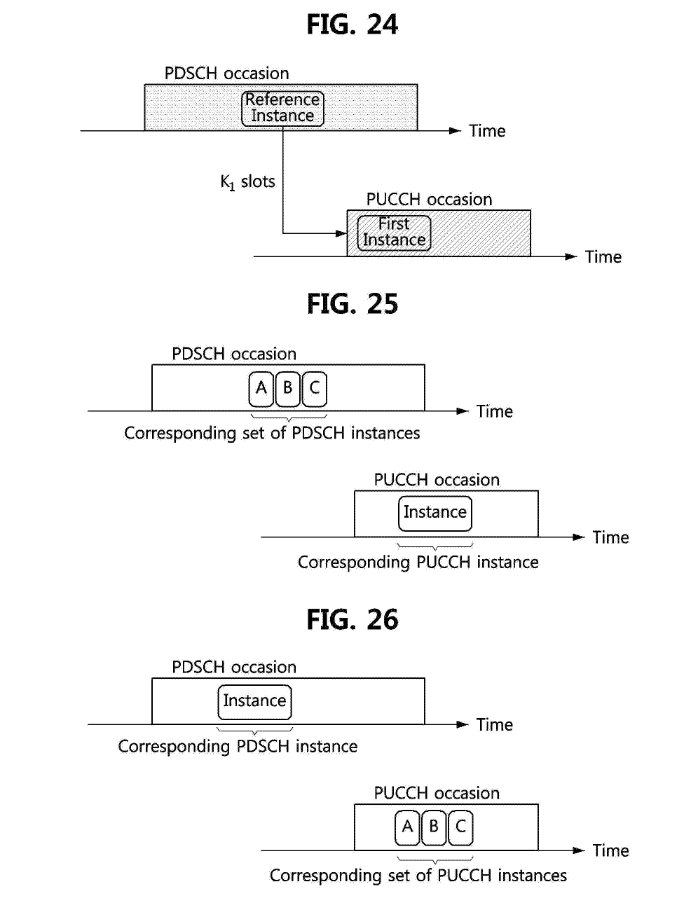

FIG. 24 is a conceptual diagram for explaining an example of a method of determining a PUCCH occasion.

Referring to FIG. 24, a timing relationship in which the UE transmits the HARQ-ACK for the PDSCH occasion to the serving base station will be described. Since the PDSCH occasion is composed of two or more PDSCH instances, it should be determined which of the PDSCH instances becomes a reference for the HARQ-ACK. Therefore, the PDSCH instances may be sorted based on the times at which the UE receives the respective PDSCH instances in the PDSCH occasion. Here, BWPs and/or component carriers (CCs) of the PDSCH instances belonging to the PDSCH occasion may be different from each other.

The UE may receive two or more PDSCH instances belonging to the PDSCH occasion at the same time. For example, if the UE receives more than one PDSCH instances in one or more BWPs or more than one CC, the UE may compare the starting symbols of the PDSCH instances, and select the PDSCH received earlier. For the PDSCHs having the same starting symbols, the UE may select the PDSCH with the earlier ending symbol. If the BWPs of the PDSCH instances are different, it is difficult to make comparison using only the starting symbols or the ending symbols, so the UE may compare locations of the PDSCH instances from boundaries of the corresponding slots in absolute temporal units (e.g., in terms of the highest sampling period).

In a proposed method, the serving base station may indicate to the UE a relative time resource for the PDSCH occasion using the DL-DCI or using a combination of the RRC signaling and the MAC CE, and the UE may identify the time resource for the PUCCH occasion based on the DL-DCI or the combination of the RRC signaling and the MAC CE. Here, the reference PDSCH instance may be the first PDSCH instance belonging to the PDSCH occasion, the last PDSCH instance belonging to the PDSCH occasion, the PDSCH instance belonging to the PDSCH occasion, in which the TB is successfully decoded (i.e., the ACK occurs), or an arbitrary PDSCH instance belonging to the PDSCH occasion.

FIG. 25 is a conceptual diagram illustrating a case where a subcarrier spacing of a PDSCH is smaller than a subcarrier spacing of a PUCCH, and FIG. 26 is a conceptual diagram illustrating a case where a subcarrier spacing of a PDSCH is larger than a subcarrier spacing of a PUCCH.

When the PDSCH and the PUCCH have different numerologies, one PDSCH instance may correspond to two or more PUCCH instances, or two or more PDSCH instances may correspond to one PUCCH instance. Referring to FIG. 25, shown is a case where the subcarrier spacing (SCS) of the PDSCH is smaller than the SCS of the PUCCH. Referring to FIG. 26, shown is a case where the SCS of the PDSCH is larger than the SCS of the PUCCH. In such the cases, channels having the smaller SCS may be regarded as a set, and the set may be mapped to a channel having the larger SCS in one-to-one manner.

In FIG. 25, since two or more PDSCH instances correspond to one PUCCH instance, the UE may decode all PDSCH instances to generate the HARQ-ACK. On the other hand, in FIG. 26, since one PDSCH instance corresponds to two or more PUCCH instances, the PUCCH instances may be equally used to transmit the HARQ-ACK for the one PDSCH instance.

(1) Method of Determining a PUCCH Occasion Based on the Last PDSCH Instance

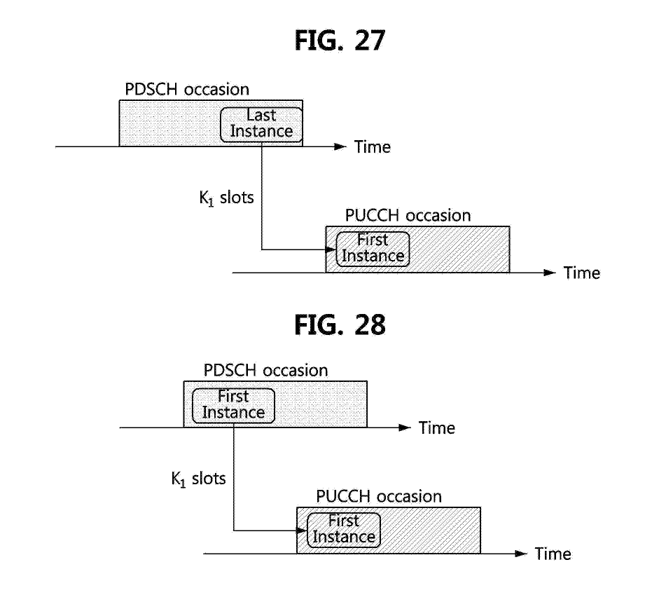

FIG. 27 is a conceptual diagram for explaining a case where a PUCCH occasion is determined based on the last PDSCH instance.

It is assumed that the UE performs decoding of the received TB after receiving all the PDSCH instances belonging to the PDSCH occasion. Thereafter, the UE may generate ACK or NACK after verifying a cyclic redundancy check (CRC) of the TB.

In an embodiment, based on the PDSCH instance transmitted last in time within the PDSCH occasion, the UE may determine the time resource for transmitting the PUCCH. For example, a slot for transmitting the PUCCH may be determined as the slot after K₁ slots from the slot in which the last. PDSCH instance is received. Information on the time resource such as the starting symbol index and the number of symbols used by the PUCCH in the slot for transmitting the PUCCH may be determined based on the PRI obtained from the DL-DCI.

(2) Method of Determining a PUCCH Occasion Based on the First PDSCH Instance

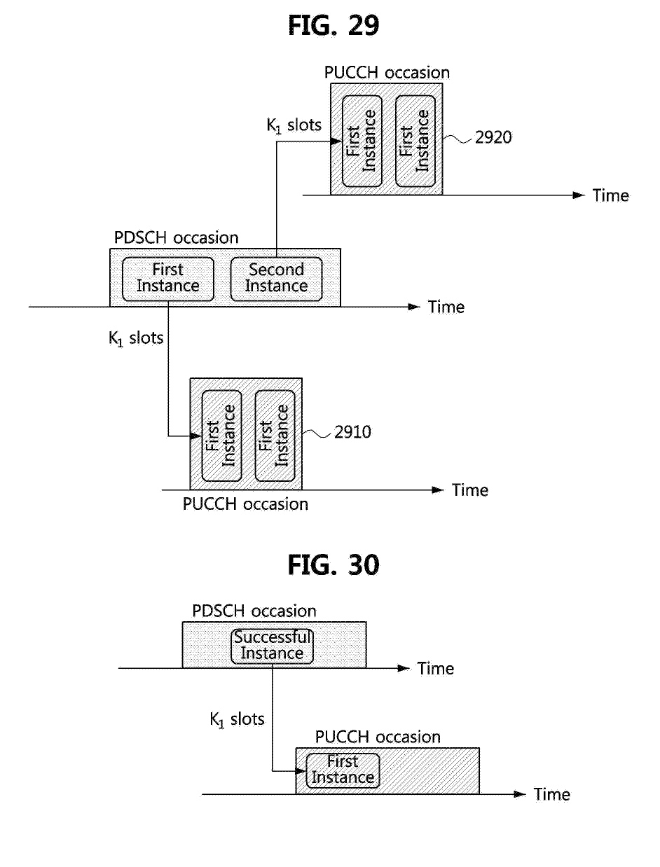

FIG. 28 is a conceptual diagram for explaining a case where a PUCCH occasion is determined based on a first PDSCH instance, and FIG. 29 is a conceptual diagram for explaining a case where a PUCCH occasion is derived based on all PDSCH instances.

In an embodiment, for each PDSCH instance included in the PDSCH occasion, the UE may transmit a PUCCH occasion for the PDSCH instance, as shown in FIG. 28. This may be applied to a case where PUCCH occasions for subsequent PDSCH instances do not overlap with each other in time. For example, when the PUCCH occasion is defined as consisting of one PUCCH instance, this may be applied.

In another embodiment, referring to FIG. 29, the UE may transmit a PUCCH occasion for each PDSCH instance, although each PDCCH occasion consists of two PUCCH instances. In this case, since the PDSCH and the PUCCH have different OFDM numerologies, they may not overlap each other in the time domain even though the PUCCH occasion is composed of two PUCCH instances.

Unlike the case illustrated in FIG. 29, when the PUCCH occasions are overlapped with each other in the time domain, the UE may differentiate the PUCCH occasions based on different resources allocated to the PUCCH occasions. Such the resources may include a frequency resource (e.g., a PRB or a frequency domain hopping pattern) or a sequence resource used by the PUCCH.

In an embodiment, based on the PDSCH instance transmitted first within the PDSCH occasion, the UE may determine the time resource for transmitting the PUCCH. For example, a slot for transmitting the PUCCH may be determined as the slot after K₁ slots from the slot in which the first PDSCH instance is received. Information on the time resource such as the starting symbol index and the number of symbols used by the PUCCH in the slot for transmitting the PUCCH may be determined based on the PRI obtained from the DL-DCI.

(3) Method of Determining a PUCCH Occasion Based on the First Successful PDSCH Instance

FIG. 30 is a conceptual diagram for explaining a case where a PUCCH occasion is determined based on a first successful PDSCH instance.

In an embodiment, the UE may select the first PDSCH instance in which the CRC of the TB CRC is verified among the PDSCH instances belonging to the PDSCH occasion, and determine the time resource at which the PUCCH occasion starts with respect to the selected PDSCH instance. For example, a slot for transmitting the PUCCH may be determined as the slot after K₁ slots from the slot in which the first successful PDSCH instance is received. Information on the time resource such as the starting symbol index and the number of symbols used by the PUCCH in the slot for transmitting the PUCCH may be determined based on the PRI obtained from the DL-DCI.

In this case, since the UE transmits the PUCCH occasion when an ACK for the PDSCH instance occurs, information other than a NACK (e.g., SR) may be transmitted as multiplexed with the ACK in a specific format of the PUCCH.

In another embodiment, the UE may not generate PUCCH instances for PDSCH instances received later in time than the selected PDSCH instance, since the PDSCH instances after the successfully decoded PDSCH instance need not be decoded.

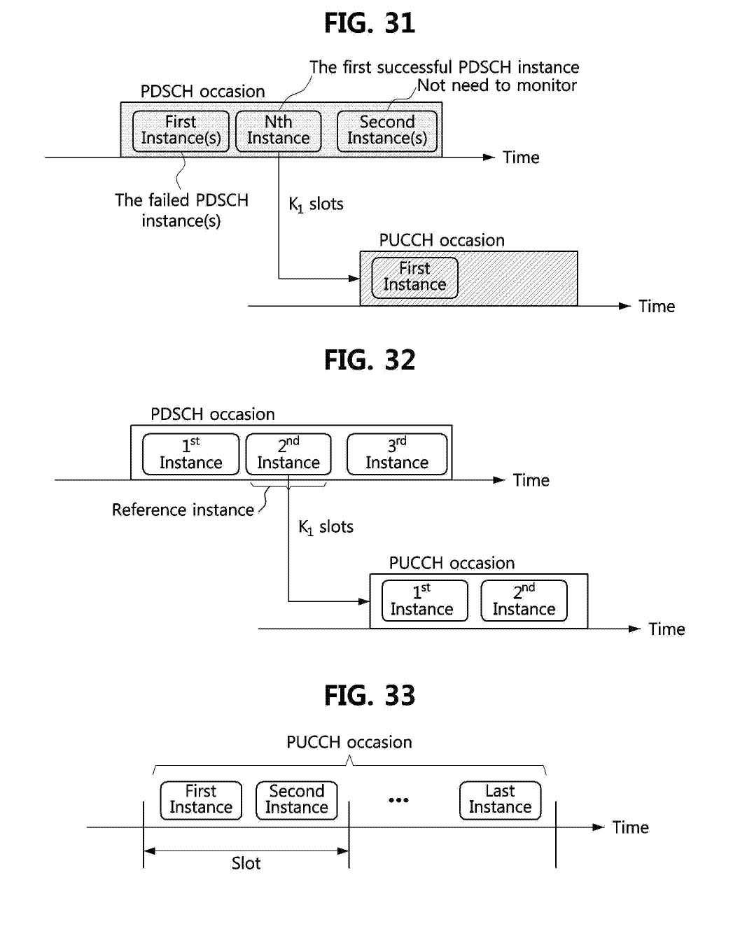

FIG. 31 is a conceptual diagram for explaining another case where a PUCCH occasion is determined based on a first successful PDSCH instance.

In yet another embodiment, if the CRC verification of the TB fails in all the PDSCH instances belonging to the PDSCH occasion, the UE may transmit a NACK. With respect to the PDSCH instance that is the last in time among all the PDSCH instances belonging to the PDSCH occasion, the UE may determine a time resource in which a PUCCH occasion starts. For example, a slot for transmitting the PUCCH may be determined as the slot after K₁ slots from the slot in which the last PDSCH instance is received. Information on the time resource such as the starting symbol index and the number of symbols used by the PUCCH in the slot for transmitting the PUCCH may be determined based on the PRI obtained from the DL-DCI. Here, the PUCCH occasion transmitted by the UE may be a PUCCH occasion for transmitting the NACK.

By applying the above-described method, the UE may transmit an ACK or a NACK for the PDSCH instance that beings to the PDSCH occasion and is located last in time in the PDSCH occasion, and transmit the ACK or nothing for the other PDSCH instances. The serving base station may reassign the PDSCH occasion to the UE by receiving the NACK.

If the UE operates in the manner of transmitting the ACK or nothing for the last PDSCH instance belonging to the PDSCH occasion, the serving base station may not be able to determine whether the UE state for the PDSCH occasion is a DTX or a NACK. Even in this case, the serving base station may reassign the PDSCH occasion to the UE identically to the above-described case. However, since the NACK is explicitly fed back from the UE, the serving base station may determine whether to control the transmission of the PDCCH or the transmission of the PDSCH.

Referring to FIG. 31, the UE may not transmit a PUCCH occasion for all the PDSCH instances belonging to the PDSCH occasion, but transmit a PUCCH occasion for the first PDSCH instance the TB CRC of which is verified (e.g., the N-th PDSCH instance in FIG. 31).

Accordingly, the PDSCH instances belonging to the PDSCH occasion may be classified into three types. The PDSCH instance(s) with temporal precedence over the N-th PDSCH instance may mean instances in which the UE fails to decode the TB (hereinafter referred to as ‘first instance(s)’). The UE may not need to decode the TB any more in the PDSCH instances (hereinafter referred to as ‘second instance(s)’) that are later in time than the N-th PDSCH instance. The N-th PDSCH instance may be the first successful PDSCH instance in which the UE succeeds in decoding the TB.

When the N-th PDSCH instance is not located last in the PDSCH occasion and there is more than one second instance(s), the UE may transmit the PUCCH occasion representing ACK to the serving base station based on the N-th PDSCH instance.

When the N-th PDSCH instance is located last in the PDSCH occasion, the UE may transmit the PUCCH occasion representing ACK to the serving base station based on the N-th PDSCH instance.

In yet another embodiment, when the N-th PDSCH instance is located last in the PDSCH occasion, the UE may transmit the PUCCH occasion representing ACK or NACK to the serving base station based on the N-th PDSCH instance.

When there is no N-th PDSCH instance and all of the PDSCH instances are the first instance(s), the UE may transmit the PUCCH occasion representing NACK to the serving base station based on the last PDSCH instance located in time.

Method of Allowing a Change of UCI in PUCCH Occasion Transmission

FIG. 32 is a conceptual diagram for explaining a case where a payload is changed in a PUCCH occasion for a PDSCH occasion composed of K PDSCH instances.

When defining a PUCCH occasion for one PDSCH instance belonging to the PDSCH occasion, the serving base station may need to detect the PUCCH occasion because the serving base station may not know the starting timing of the first PUCCH instance in the PUCCH occasion. Therefore, it may be possible to reduce the operation burden of the serving base station by setting the time resource at which the PUCCH occasion starts.

In an embodiment, the serving base station may indicate to the UE a time resource relative to the PDSCH occasion (i.e., reference PDSCH instance) through the DL-DCI, and the UE may configure the PUCCH occasion based on the relative time resource indicated by the serving base station.

The UE may start the PUCCH occasion after K₁ slots from the reference instance of the PDSCH occasion. Here, the reference instance may be the first instance of the PDSCH occasion, the last instance of the PDSCH occasion, or an arbitrary instance belonging to the PDSCH occasion. The reference instance may be configured by the serving base station through the RRC signaling or the DL-DCI.

In an embodiment, when transmitting a PUCCH instance, the UE may regard a result of soft combining of the predetermined number of PDSCH instances corresponding to the PUCCH instance as an HARQ-ACK included in the corresponding PUCCH instance. Accordingly, each PUCCH instance may be granted a combining window composed of its corresponding PDSCH instances. As an example of a method of determining the reference PDSCH instance at the serving base station, the reference PDSCH instance may be determined based on the number of PDSCH instances with which the UE can determine the decoding (i.e., soft combining) result corresponds to ACK.

Referring to FIG. 32, the first PUCCH instance may have ACK/NACK information generated by combining the first PDSCH instance and the second PDSCH instance which is the reference instance. Also, the second PUCCH instance may have ACK/NACK information generated by combining the first PDSCH instance, the second PDSCH instance which is the reference instance, and the third PDSCH instance.

Accordingly, the UE may transmit different HARQ-ACKs to the serving base station in the first PUCCH instance and the second PUCCH instance. For example, the UE may transmit a NACK in the first PUCCH instance and transmit an ACK in the second PUCCH instance. The serving base station may be assumed to be able to reliably detect each PUCCH instance.

PUCCH Occasion Configuration

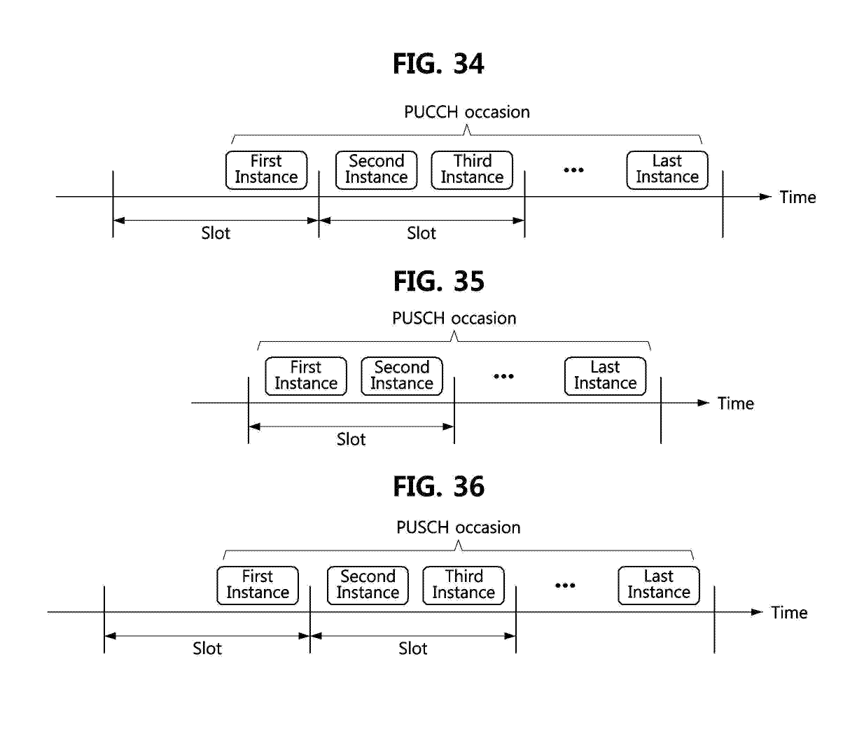

FIG. 33 is a conceptual diagram illustrating a configuration of a PUCCH occasion starting at a boundary of a slot, and FIG. 34 is a conceptual diagram illustrating a configuration of a PUCCH occasion starting at a position within a slot.

When the communication system operates in the FDD mode, the downlink may operate at a high frequency and the uplink may operate at a low frequency. Therefore, the PDSCH may be transmitted in form of the occasion, but the PUCCH may sufficiently obtain a required link quality even by a single transmission. However, when the uplink and downlink have similar communication ranges or when the communication system operates in the TDD mode, it may be difficult for the serving base station to normally receive the single PUCCH transmission. Therefore, it may be generally preferable that both the PDSCH and the PUCCH are transmitted in form of the occasion.

Hereinafter, a case of transmitting one or more PUCCH instances will be considered. This may be defined as a PUCCH occasion, and one PUCCH occasion may consist of one or more PUCCH instances. The UE may transmit a PUCCH once in each PUCCH instance. In the PUCCH occasion, it may be possible to configure several PUCCH instances in the same symbol, but it is preferable to configure only one PUCCH instance in the same symbol considering the transmission power of the UE.

Referring to FIGS. 33 and 34, the PUCCH occasion may be configured as a set of PUCCH instances. The PUCCH occasion may include one or more PUCCH instances within a slot.

In a proposed method, the PUCCH occasion may be started at the boundary of the slot. As shown in FIG. 33, when two PUCCH instances in one slot may be configured in the UE through the RRC signaling, even if the UE generates an HARQ-ACK in the middle of the corresponding slot, the generated HARQ-ACK may be transmitted from the next slot located subsequently from the corresponding slot. According to this method, since the average interference amount of the slot can be maintained when the PUCCH instance transmitted by the UE is multiplexed with an uplink signal of another UE, the serving base station can estimate an interference covariance. However, since the UE has to wait for the boundary of the slot, the delay of the downlink traffic may increase.

In another proposed method, the PUCCH occasion may start at a position within the slot. As shown in FIG. 34, when two PUCCH instances in one slot are configured to the UE through the RRC signaling, if the UE generates an HARQ-ACK in the middle of the corresponding slot, the generated HARQ-ACK may be transmitted from the corresponding slot. According to this method, since the average interference amount of the slot cannot be maintained when the PUCCH instance transmitted by the UE is multiplexed with an uplink signal of another UE, it may be difficult for the serving base station to estimate an interference covariance. However, since the UE does not need to wait for the slot boundary, the delay of the downlink traffic may decrease.

The serving base station may specify the earliest PUCCH instance belonging to the PUCCH occasion to configure the time region of the PUCCH occasion to the UE through the RRC signaling. According to a predetermined rule, the UE may apply a time difference for the HARQ-ACK through the DL-DCI based on one PDSCH instance belonging to the PDSCH occasion.

The serving base station may configure the time length of the PUCCH occasion to the UE through the RRC signaling. The length may be defined in units of slots (e.g., X slots), and may also be defined as the number of PUCCH instances (e.g., Z).

The serving base station may indicate the starting symbol index and the number of symbols of the PUCCH instance to the UE through a combination of the DL-DCI and the RRC signaling. Each of the PUCCH instances may be composed of the same number of symbols. When the UE can transmit Z or less PUCCH instances in one slot, and the interval between the PUCCH instances in the slot is denoted by W, W may have a value of floor (14/Z). When the starting symbol index is denoted by Y, the UE may represent the starting symbol indexes of the respective PUCCH instances as (Y mod W), (Y mod W+W), (Y mod W+2*W), . . . , and (Y mod W+(Z−1)*W) based on a modulo operation of Y and W.

Determination of Spatial Filter for PUCCH Instances

The TCI states applied to the PUCCH occasion may be classified into the case of the PUCCH sweeping transmission and the case of the PUCCH repetitive transmission. In the case of the PUCCH sweeping transmission, the UE may be configured through the RRC signaling such that the PUCCH instances belonging to the PUCCH occasion have different TCI states. The PUCCH instances may be received by different reception points (R×Ps). In the case of the PUCCH repetitive transmission, the UE may be configured through the RRC signaling such that all the PUCCH instances belonging to the PUCCH occasion have the same TO state.

In a proposed method, the two cases may be distinguished by a separate RRC signaling. The same TCI state may be applied to all the PUCCH instances belonging to the PUCCH occasion, or different TO states may be applied to the PDDCH instances belonging to the PUCCH occasion.

In another proposed method, both the MAC CE and the RRC signaling may be used to configure the TO states applied to the PUCCH instances. The serving base station may configure one or more sets of TCI states to the UE through the RRC signaling. The serving base station may select one among the sets of TCI states based on a feedback from the UE or determination of the serving base station, and indicate the selected set among the sets of TCI states to the UE by using the MAC CE.

In another proposed method, the TO state applied to the PUCCH instance may be configured without any separate RRC signaling. When the type of UCI is the HARQ-ACK, the DCI may be involved in the process of receiving the PDSCH and transmitting the PUCCH. For example, in order to transmit the HARQ-ACK corresponding to the PDSCH instance received by the UE, the PUCCH instance for which a TCI state associated with the TCI state of the received PDSCH instance is configured may be used. When transmitting a PUCCH occasion for one PDSCH instance, the first PUCCCH instance of the PUCCH occasion may follow the TCI state associated with the TCI state of the received PDSCH instance.

For subsequent PUCCH instances belonging to the PUCCH occasion, the serving base station may configure the PUCCH occasion to the UE and apply the order of the TCI states provided or may apply the order of the TCI states defined in the technical specification.

In a proposed method, the RRC signaling may be used to configure the order of TCI states applied to the PUCCH occasion.

In another proposed method, the order of the TCI states applied to the PUCCH occasion may be derived from the PDSCH occasion. This scheme may be applied when the number of PDSCH instances belonging to the PDSCH occasion is equal to the number of PUCCH instances belonging to the PUCCH occasion. For example, the PDSCH occasion may have K PDSCH instances, and the UE may be assumed to know that the TCI states may be applied to the respective PDSCH instances in the order of (TC 1, TC 2, . . . , and TC K). In this case, the UE may apply a TCI a associated with the TCI 1 to the PUCCH instance corresponding to the PDSCH instance to which the TCI 1 state is applied, and apply a TCI b associated with the TCI 2 to the PUCCH instance corresponding to the PDSCH instance to which the TCI 2 state is applied. This may be repeated until the TCI K.

In yet another proposed method, the order of the TCI states applied to the PUCCH occasion may be derived based on the PDSCH occasion and the RRC signaling. Thereafter, a TCI state corresponding to the TCI state applied to the first PDSCH instance indicated by the DL-DCI may be determined as a TCI state applied to the first PUCCH instance of the PUCCH occasion. Thereafter, the UE may determine the TCI states applied to the PUCCH occasion according to the order configured through the RRC signaling. Alternatively, the order of the TCI states applied to the PUCCH occasion may be defined in accordance with the technical specification.

For example, the serving base station may configure the order of the TCI states applied to the PUCCH instances to the UE in the order of (a, b, c, d, e, . . . ) through the RRC signaling. In the DL-DCI received by the UE, the TCI state of the first PDSCH instance of the PDSCH occasion may be indicated as the TCI 3. In this case, the UE may determine the third value (i.e., TCI c) corresponding to the TCI 3 in the order of the TCI states applied to the PUCCH instances as the TCI state applied to the first PUCCH instance of the PUCCH occasion. For the second and subsequent PUCCH instances of the PUCCH occasion, the TCI states may be applied in the order of (TCI d, TCI e, . . . , etc.). If the TCI state of the first PDSCH instance configured through the DL-DCI is the last in the signaled order of the TCI states, the first value in the signaled order may be applied again to the next PUCCH instance. For example, it may be assumed that the serving base station configures the order (a, b, c, d) of TCI states to the UE, and the PUCCH occasion includes 6 PUCCH instances. In this case, if the TCI state of the first PDSCH instance of the PDSCH occasion corresponds to the TCI a, the UE may apply the TCI states to the PUCCH instances included in the PUCCH occasion in the order of (a, b, c, d, a, b). As another example, it may be assumed that the serving base station configures the order (a, b, c, d) of TCI sates to the UE, and the PUCCH occasion includes 2 PUCCH instances. In this case, if the TCI state of the first PDSCH instance of the PDSCH occasion corresponds to the TCI a, the UE may apply the TCI states to the PUCCH instances included in the PUCCH occasion in the order of (a, b).

On the other hand, when the type of UCI is a periodic CSI, a semi-persistent CSI, or an SR, or when the PDSCH is scheduled in a semi-persistent manner, the serving base station may configure the TCI states applied to the PUCCH instances belonging to the PUCCH occasion through the RRC signaling. This is because the DCI is not involved in these cases.

Power Control of PUCCH Instance

The transmit power of the PUCCH instance may be determined according to a link budget between the UE and an R×P. The UE may actually determine the transmission power of the PUCCH by cumulatively applying one or more transmit power control (TPC) commands.

When the UE applies the same precoding to the PUCCH instances as in the case of the PUCCH repetitive transmission, the UE may transmit the PUCCH instances to the R×P by using the same transmission power. However, when the UE applies different precoding to the PUCCH instances as in the PUCCH sweeping transmission, the UE may transmit the PUCCH instances to the R×P by using a different transmission power for each PUCCH instance. Here, proposed is a method for determining the magnitude of transmission power applied to the PUCCH instance.

In a proposed method, the serving base station may indicate to the UE a transmission power applied to each R×P though the RRC signaling and the DCI. A transmission power for each power control process may be indicated to the UE by the serving base station, and the UE may apply one or more power control processes to the PUCCH occasion. The serving base station may configure an initial power P0 for each power control process to the UE through the RRC signaling. The UE may derive a power to be applied to the PUCCH instance by accumulating TPC commands for each power control process and reflecting an RSRP estimate thereto. The serving base station may associate the PUCCH instance with the power control process of the PUCCH when configuring the PUCCH occasion.

In another proposed method, the serving base station may indicate one of applicable powers, which is to be applied to each R×P, to the UE through the RRC signaling and the DCL The UE may be configured to have one power control process, and may apply the power control process to the PUCCH occasion as it is, or modify the power control process and apply the modified power control process to the PUCCH occasion. The serving base station may configure an initial power P0 for each power control process to the UE through the RRC signaling. The UE may derive a power to be applied to the PUCCH instance by accumulating TPC commands for each power control process and reflecting an RSRP estimate thereto. The serving base station may associate the PUCCH instance with the power control process of the PUCCH when configuring the PUCCH occasion. Although the power control processes use the same P0 and TPC commands, the UE may apply a different RSRP estimate to each PUCCH instance, and derive a different power for each PUCCH instance.

Configuration of PUSCH Occasion

FIG. 35 is a conceptual diagram illustrating a configuration of a PUSCH occasion starting at a boundary of a slot, and FIG. 36 is a conceptual diagram illustrating a configuration of a PUSCH occasion starting at a position within a slot.

In order to receive an uplink grant and transmit a PUSCH, the serving base station may transmit a PDCCH occasion, and the UE may transmit a PUSCH occasion in response to the uplink grant. Alternatively, without an uplink grant, the RRC signaling or the RRC signaling and the L1 activation may be used to cause the UE to transmit the PUSCH occasion.

The PUSCH occasion may mean transmitting the PUSCH more than once, and one PUSCH occasion may be composed of one or more PUSCH instances. In each PUSCH instance, the UE may transmit the PUSCH once. In the PUSCH occasion, a plurality of PUSCH instances may be configured in the same symbol, but it is preferable to configure only one PUSCH instance in the same symbol in consideration of the transmission power of the UE.

In an environment where a required link quality (e.g., a target error rate of a link) cannot be sufficiently obtained by a single PUSCH transmission, the PUSCH may be transmitted in form of the PUSCH occasion, so that the serving base station can receive the PUSCH.

In an embodiment in which the PDCCH occasion is monitored for transmission of a PUSCH occasion, the first PUSCH instance of the PUSCH occasion may be derived from the first uplink grant successfully received. Then, the UE may assume that there is no PDCCH occasion that allocates another PUSCH occasion before the PUSCH occasion is completed.

In another embodiment, the UE may assume that the UE is able to receive a new PDCCH occasion while the PDCCH occasion is in progress. That is, two or more PDCCH occasions may overlap in time. Since the UE can receive an uplink grant for a new UL TB, even when the UE has detected an uplink grant in one PDCCH occasion, the UE may continue to monitor PDCCH instances belonging to another PDCCH occasion.

In a proposed method for transmitting the PUSCH occasion, the UE may transmit one or more PUSCH instances within a slot, and may start the PUSCH occasion within the slot as well as at the boundary of the slot.

The PUSCH occasion may consist of one or more PUSCH instances, and one PUSCH instance may transmits an UL TB. The serving base station may configure the PUSCH occasion the UE through the RRC signaling. The PUSCH instances may have the same PRB assignment and the same number of symbols. In the proposed method, the number of PUSCH instances included in the PUSCH occasion may be indicated to the UE by the serving base station through the UL-DCI, or may be indicated to the UE by using only the RRC signaling. In the case of using the UL-DCI, the serving base station may configure a set of candidate values to the UE through the RRC signaling, and select one value from the set of candidate values by using the UL-DCI.

Configuration of Redundancy Version for PUSCH Instances

The PUSCH instances included in the PUSCH occasion may all have the same redundancy version (RV) or have different RVs.

In a proposed method, if the serving base station does not provide a separate RRC signaling to the UE, the UE may assume that the PUSCH instances have RVs predefined in the technical specification. As an example, the UE may apply RVs to PUSCH instances in order of (0, 2, 3, 1). As another example, the UE may apply RVs to the PUSCH instances in order of (0, 0, 0, 0), or the UE may apply RVs to the PUSCH instances in order of (0, 2, 0, 2).

In another proposed method, if the serving base station does not provide the RRC signaling to the UE, the UE may assume that all the PUSCH instances have the same RV, and apply an RV included in the UL-DCI received from the serving base station to all the PUSCH instances. For example, when the UE detects an RV x in the UL-DCI received from the serving base station, the UE may apply the RV in the order of (x, x, x, x) to the PUSCH instances.

In yet another proposed method, the order of the RVs may be defined in the technical specification, and the serving base station may indicate to the UE a starting value of the RVs applied to the PUSCH instances among the predefined RVs in the technical specification by using the UL-DCI. For example, when the specification defines the order of RVs as (x, y, z, w, . . . ), if the UL-DCI indicates the RV z to the UE, the UE may apply the RVs to the PUSCH instances in the order of (z, w, . . . ).

In yet another proposed method, the serving base station may configure RV vectors to the UE through the RRC signaling. The UE may know which RV vector is to be applied by using a value obtained from the UL-DCI received from the serving base station. For example, the serving base station may configure J (J≥1) RV vectors each of which is composed of 4 values (RV a, RV b, RV c, RV d) to the UE through the RRC signaling. The UE may use the j-th RV vector among the J RV vectors by using a value derived from the UL-DCI received from the serving base station, and identify the RVs applied to the PUSCH instances using the j-th RV vector. For example, the RV a and the RV b may be sequentially applied in the order of the PUSCH instances belonging to the PUSCH occasion. When there are fewer than 4 PUSCH instances, the RVs are applied in the order (e.g., if there are only 3 PUSCH instances, the RV a, RV b, and RV c may be applied). When there are more than 4 PUSCH instances, the RV vector may be applied in a cyclic manner so that the RV a may be applied after the RV d. For convenience of description, it is assumed that the above-described examples have 4 PUSCH instances, but the above-described method may be applied even when the number of PUSCH instances is different.

Determination of Spatial Filter for PUSCH Instances

A case where a precoder used by the UE is determined by the serving base station may be considered.

The PUSCH instances belonging to the PUSCH occasion may have the same transmit PMI (TPMI) or the same SRI, or may have different TPMIs or different SRIs. The serving base station may notify the TPMI(s) or the SRI(s) applied to the PUSCH instances included in the PUSCH occasion to the UE in form of a list by the RRC signaling. When the PUSCH occasion is assumed to include 4 PUSCH instances for convenience of explanation, the list may be configured to have 4 elements indicated by indexes 0, 1, 2, and 3, and each element may be configured to indicate a TPMI, an SRI, and the number of layers so that the UE can determine a receiving spatial filter based on the RRC signaling. However, when transmitting the PUSCH occasion, the UE may apply the SRI or the TPMI to the PUSCH instance, but may not apply a combination of the SRI and the TPMI to the PUSCH instance.

In an embodiment, if the serving base station does not provide the list to the UE through the RRC signaling, the UE may assume that the PUSCH instances included in the PUSCH occasion have indexes predefined in the technical specification. As an example, the UE may apply indexes to PUSCH instances in order of (0, 1, 2, 3). This may correspond to a PUSCH sweeping scheme. As another example, the UE may apply indexes to the PUSCH instances in order of (0, 0, 0, 0). This may correspond to a PUSCH repetition scheme. As another example, the UE may apply indexes to the PUSCH instances in order of (0, 2, 0, 2). This may correspond to a partial PUSCH sweeping scheme.

In another embodiment, the serving base station may configure TCI states applied to the PUSCH instances by utilizing both the MAC CE and the RRC signaling. The serving base station may configure one or more sets of TCI states to the UE through the RRC signaling. The serving base station may select one among the sets of TCI states based on a feedback from the UE or determination of the serving base station, and indicate the selected set among the sets of TCI states to the UE by using the MAC CE.

In another embodiment, if the serving base station does not provide the list to the UE through the RRC signaling, the UE may assume that all the PUSCH instances included in the PUSCH occasion have the same index, and apply a TPMI or an SRI (i.e., index) included in the UL-DCI to all the PUSCH instances. For example, when the UE detects an index x in the UL-DCI, the UE may apply the index in the order of (x, x, x, x) to the PUSCH instances of the PUSCH occasion.

In yet another embodiment, the order of the indexes applied to the PUSCH instances of the PUSCH occasion may be defined in the technical specification, and the serving base station may indicate to the UE a starting, value of the indexes applied to the PUSCH instances among the predefined indexes in the technical specification by using the UL-DCI. For example, when the specification defines the order of indexes as (x, y, z, w, . . . ), if the UL-DCI indicates the index z to the UE, the UE may apply the indexes to the PUSCH instances in the order of (z, w, . . . ).

In yet another embodiment, the serving base station may configure index vectors to the UE through the RRC signaling. The UE may identify which index vector is to be applied by using a value obtained from the UL-DCI received from the serving base station. For example, the serving base station may configure J (J≥1) index vectors each of which is composed of 4 indexes (a, b, c, d) to the UE through the RRC signaling. The UE may use the j-th index vector among the J index vectors by using a value derived from the UL-DCI received from the serving base station, and identify the indexes, applied to the PUSCH instances using the j-th index vector. For example, the index a and the index b may be sequentially applied in the order of the PUSCH instances belonging to the PUSCH occasion. When there are fewer than 4 PUSCH instances, the indexes are applied in the order (e.g., if there are only 3 PUSCH instances, the indexes a, b, and c may be applied). When there are more than 4 PUSCH instances, the index vector may be applied in a cyclic manner so that the index a may be applied after the index d. For convenience of description, it is assumed that the above-described examples have 4 PUSCH instances, but the above-described method may be applied even when the number of PUSCH instances is different.

Power Control of PUSCH Instance

The transmit power of the PUSCH instance may be determined according to a link budget between the UE and an R×P. The UE may actually determine the transmission power of the PUSCH by cumulatively applying one or more transmit TPC commands.

When the UE applies the same precoding to the PUSCH instances as in the case of the PUSCH repetitive transmission, the UE may transmit the PUSCH instances to the R×P by using the same transmission power. However, when the UE applies different precoding to the PUSCH instances as in the PUSCH sweeping transmission, the UE may transmit the PUSCH instances to the R×P by using a different transmission power for each PUSCH instance. Here, proposed is a method for determining the magnitude of transmission power applied to the PUSCH instance.

In a proposed method, the serving base station may indicate to the UE a transmission power applied to each R×P through the RRC signaling and the DCI. A transmission power for each power control process may be indicated to the UE by the serving base station, and the UE may apply one or more power control processes to the PUSCH occasion. The serving base station may configure an initial power P0 and a for each power control process to the UE through the RRC signaling. The UE may derive a power to be applied to the PUSCH instance by accumulating TPC commands for each power control process and reflecting an RSRP estimate thereto. The serving base station may associate the PUSCH instance with the power control process of the PUSCH when configuring the PUSCH occasion.

In another proposed method, the serving base station may indicate one of applicable powers, which is to be applied to each R×P, to the UE through the RRC signaling and the DCL The UE may be configured to have one power control process, and may apply the power control process to the PUSCH occasion as it is, or modify the power control process and apply the modified power control process to the PUSCH occasion. The serving base station may configure an initial power P0 and a for each power control process to the UE through the RRC signaling. The UE may derive a power to be applied to the PUSCH instance by accumulating TPC commands for each power control process and reflecting an RSRP estimate thereto. The serving base station may associate the PUSCH instance with the power control process of the PUSCH when configuring the PUSCH occasion. Although the power control processes use the same P0 and TPC commands, the UE may apply a different RSRP estimate to each PUSCH instance, and derive a different power for each PUSCH instance.

The embodiments of the present disclosure may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present disclosure or can be publicly known and available to those who are skilled in the field of computer software.

Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the embodiments of the present disclosure, and vice versa.

While the embodiments of the present disclosure and their advantages have been described in detail, it should be understood that various changes, substitutions and alterations may be made herein without departing from the scope of the present disclosure.

What is claimed is:

1. A method of transmitting a grant-free uplink data channel (physical uplink shared channel (PUSCH)) (GF-PUSCH), performed in a terminal, the method comprising:
determining a resource (GF-PUSCH resource) for transmission of the GF-PUSCH and an identifier (DM-RS ID) of a demodulation reference signal (DM-RS) included in the GF-PUSCH;
when an uplink traffic arrives, encoding the uplink traffic into a transport block (TB);
generating the DM-RS based on the DM-RS ID, and transmitting the GF-PUSCH including the TB and the DM-RS to a base station through the GF-PUSCH resource; and
receiving, from the base station, a group hybrid automatic repeat request acknowledgement (HARQ-ACK) information in which ACK or negative acknowledgement (ACK/NACK) information for the GF-PUSCH of the terminal and ACK/NACK information for at least one GF-PUSCH of at least one other terminal are multiplexed, through a downlink control information (DCI).

2. The method according to claim 1, wherein the group ACK/NACK information is configured to comprise at most M DM-RS IDs detected by the base station in each of N GF-PUSCH resources or a bit string including values derived from the at most M DM-RS IDs, wherein N is a natural number equal to or greater than 1, and M is a natural number equal to or greater than 1.

3. The method according to claim 2, wherein the bit string further includes an identifier of a GF-PUSCH resource in which one or more DM-RSs are detected by the base station.

4. The method according to claim 2, wherein the bit string further includes a number of DM-RS IDs detected by the base station in each of the N GF-PUSCH resources.

5. The method according to claim 1, wherein the group ACK/NACK information is configured as a bitmap indicating at most M DM-RS IDs detected by the base station in each of N GF-PUSCH resources or values derived from the at most M DM-RS IDs, wherein N is a natural number equal to or greater than 1, and M is a natural number equal to or greater than 1.

6. The method according to claim 1, wherein the GF-PUSCH resource is configured to the terminal by the serving base station, or is selected by the terminal in a resource pool configured to the terminal by the serving base station through a higher layer signaling.

7. The method according to claim 1, further comprising receiving a number K of repetitive transmissions for the GF-PUSCH from the base station, wherein, in the transmitting the GF-PUSCH, the GF-PUSCH is repetitively transmitted to the base station K times.

8. The method according to claim 7, wherein, when the ACK/NACK information for the GF-PUSCH of the terminal indicates ACK after k (k repetitive transmissions of the GF-PUSCH, the transmission of the GF-PUSCH is early terminated.

9. A method of receiving a grant-free uplink data channel (physical uplink shared channel (PUSCH)) (GF-PUSCH), performed in a base station, the method comprising:
detecting a demodulation reference signal (DM-RS) of the GF-PUSCH transmitted from a terminal through a resource (GF-PUSCH resource) for transmission of the GF-PUSCH, and determining an identifier (DM-RS ID) of the DM-RS;
decoding a transport block (TB) included in the GF-PUSCH based on the detected DM-RS;
transmitting, to the terminal, a group hybrid automatic repeat request acknowledgement (HARQ-ACK) information in which ACK or negative acknowledgement (ACK/NACK) information for the GF-PUSCH of the terminal and ACK/NACK information for at least one GF-PUSCH of at least one other terminal are multiplexed, through a downlink control information (DCI), the ACK/NACK information for the GF-PUSCH of the terminal being generated according to a result of the decoding of the TB.

10. The method according to claim 9, wherein the group ACK/NACK information is configured to comprise at most M DM-RS IDs detected by the base station in each of N GF-PUSCH resources or a bit string including values derived from the at most M DM-RS Ms, wherein N is a natural number equal to or greater than 1, and M is a natural number equal to or greater than 1.

11. The method according to claim 10, wherein the bit string further includes an identifier of a GF-PUSCH resource in which one or more DM-RSs are detected by the base station.

12. The method according to claim 10, wherein the bit string further includes a number of DM-RS Os detected by the base station in each of the N GF-PUSCH resources.

13. The method according to claim 9, wherein the group ACK/NACK information is configured as a bitmap indicating at most M DM-RS IDs detected by the base station in each of N GF-PUSCH resources or values derived from the at most M DM-RS IDs, wherein N is a natural number equal to or greater than 1, and M is a natural number equal to or greater than 1.

14. The method according to claim 9, wherein the GF-PUSCH resource is configured to the terminal by the serving base station, or is selected by the terminal in a resource pool configured to the terminal by the serving base station through a higher layer signaling.

15. The method according to claim 9, further comprising indicating a number K of repetitive transmissions for the GF-PUSCH to the terminal, and the GF-PUSCH is repetitively transmitted K times from the terminal through the GF-PUSCH resource.

16. The method according to claim 15, wherein, when the decoding of the TB succeeds after k (k≤K) repetitive transmissions of the GF-PUSCH, the transmission of the GF-PUSCH of the terminal is early terminated by transmitting ACK/NACK information indicating ACK for the GF-PUSCH of the terminal as multiplexed in the group ACK/NACK information.

17. A terminal for transmitting a grant-free uplink data channel (physical uplink shared channel (PUSCH)) (GF-PUSCH), the terminal comprising at least one processor, a memory storing at least one instruction executed by the at least one processor, and a transceiver controlled by the at least one processor, wherein the at least one instruction is configured to:
determine a resource (GF-PUSCH resource) for transmission of the GF-PUSCH and an identifier (DM-RS ID) of a demodulation reference signal (DM-RS) included in the GF-PUSCH;
when an uplink traffic arrives, encode the uplink traffic into a transport block (TB);
generate the DM-RS based on the DM-RS ID, and transmit the GF-PUSCH including the TB and the DM-RS to a base station through the GF-PUSCH resource; and
receive, from the base station, a group hybrid automatic repeat request acknowledgement (HARQ-ACK) information in which ACK or negative acknowledgement (ACK/NACK) information for the GF-PUSCH of the terminal and ACK/NACK information for at least one GF-PUSCH of at least one other terminal are multiplexed, through a downlink control information (DCI).

18. The terminal according to claim 17, wherein the group ACK/NACK information is configured to comprise at most M DM-RS IDs detected by the base station in each of N GF-PUSCH resources or a bit string including values derived from the at most M DM-RS Os, wherein N is a natural number equal to or greater than 1, and M is a natural number equal to or greater than 1.

19. The terminal according to claim 17, wherein the group ACK/NACK information is configured as a bitmap indicating at most M DM-RS IDs detected by the base station in each of N GF-PUSCH resources or values derived from the at most M DM-RS Os, wherein N is a natural number equal to or greater than 1, and M is a natural number equal to or greater than 1.

20. The terminal according to claim 17; wherein the GF-PUSCH resource is configured to the terminal by the serving base station, or is selected by the terminal in a resource pool configured to the terminal by the serving base station through a higher layer signaling.
